(19) United States
(12) Patent Application Publication
(10) Pub. No.: US 2026/0323708 A1
(43) Pub. Date: Oct. 15, 2026

(54) METHODS AND APPARATUSES FOR ACCESS PROCEDURES AND COMMON SSB FOR LOW-POWER RADIO AND MAIN RADIO

(71) Applicant: InterDigital Patent Holdings, Inc., Wilmington, DE (US)

(72) Inventors: Young Woo Kwak, Woodbury, NY (US); Nazli Khan Beigi, Longueuil (CA); Virgile Garcia, Antibes (FR); Moon IL Lee, Melville, NY (US); Paul Marinier, Brossard (CA); Jongwoo Hong, New York, NY (US); Tao Deng, New York, NY (US); Jaya Rao, Montreal (CA); Prasanna Herath, Laval (CA)

(73) Assignee: InterDigital Patent Holdings, Inc., Wilmington, DE (US)

(21) Appl. No.: 19/174,851

(22) Filed: Apr. 9, 2025

(51) Int. Cl. H04W 74/0833; H04L 27/02; H04W 56/00

(52) U.S. Cl. CPC H04W 74/0833; H04L 27/02; H04W 56/0015

(57) ABSTRACT

Methods, apparatuses, and systems are disclosed. In one example, a method performed by a wireless transmit/receive unit (WTRU) may involve determining at least a portion of a cell identity (ID) based on an on/off pattern associated with a synchronization signal block (SSB); receiving, via a low-power radio, an on-off keying (OOK)-based physical broadcast channel (PBCH) based on the portion of the cell ID and the on/off pattern; transmitting, via the low-power radio, a low-power preamble in one or more uplink resources; and receiving, via the low-power radio, an OOK-based random access response (RAR) that indicates that the low-power preamble was received.

### BACKGROUND

Low-power radios generally consume less power than main radios. Low-power-radios may generally use simple forms of modulation (e.g., amplitude modulation), while main radios may generally use more complex forms of modulation (e.g., orthogonal frequency-division multiplexing). Compared to low-power radios, main radios generally have much higher spectral efficiency and are more robust in the face of interference and/or multipath fading.

### SUMMARY

Methods and apparatuses for operation by a wireless transmit/receive unit (WTRU) are provided.

In an example, a method performed by a WTRU may include determining at least a portion of a cell identity (ID) based on an on/off pattern associated with a synchronization signal block (SSB); receiving, via a low-power radio, an on-off keying (OOK)-based physical broadcast channel (PBCH) based on the portion of the cell ID and the on/off pattern; transmitting, via the low-power radio, a low-power preamble in one or more uplink resources; and receiving, via the low-power radio, an OOK-based random access response (RAR) that indicates that the low-power preamble was received.

The transmission of the low-power preamble and the reception of the OOK-based RAR may be a first portion of a random access channel (RACH) procedure, and

The method may further include determining to use a main radio for performing a second portion of the RACH procedure.

The method may further include receiving configuration information that indicates a condition; and determining to use the main radio for performing the second portion of the RACH procedure based on the condition.

The low-power preamble may indicate a device type of the WTRU.

The portion of the cell ID based on the on/off pattern may comprise two bits that are indicated by the on/off pattern.

The method may further comprise receiving configuration information that indicates the low-power radio is to be used for initial access.

The OOK-based RAR may indicate a time associated with the transmission of the low-power preamble.

The method may further comprise receiving, via the main radio, a primary synchronization signal (PSS) and a secondary synchronization signal (SSS) in the SSB, wherein the SSB comprises an on-off keying (OOK)-based on/off pattern; determining the cell ID based on the PSS, the SSS, and the OOK-based on/off pattern; receiving, via the main radio, an orthogonal frequency-division multiplexing (OFDM)-based physical broadcast channel (PBCH) based on timing information associated with the PSS and the SSS; receiving, via the main radio and based on the OFDM-based PBCH, a system information block (SIB); and transmitting a message via the main radio and based on the SIB.

The method may further comprise receiving the OFDM-based PBCH via a first set of transmission occasions; and receiving the OOK-based PBCH via a second set of transmission occasions.

The first set of transmission occasions may be a set of even-numbered transmission occasions. The second set of transmission occasions may be a set of odd-numbered transmission occasions.

The low-power radio may be characterized by a capacity to use OOK and a lack of a capacity to use OFDM. The main radio may be characterized by the capacity to use OFDM.

In an example, a method performed by a WTRU may include receiving, via a main radio, a primary synchronization signal (PSS) and a secondary synchronization signal (SSS) in a synchronization signal block (SSB), wherein the SSB comprises an on-off keying (OOK)-based on/off pattern; determining a cell identity (ID) based on the PSS, the SSS, and the OOK-based on/off pattern; receiving, via the main radio, an orthogonal frequency-division multiplexing (OFDM)-based physical broadcast channel (PBCH) based on timing information associated with the PSS and the SSS; receiving, via the main radio and based on the OFDM-based PBCH, a system information block (SIB); and [0016]transmitting a message via the main radio and based on the SIB.

The method may further comprise receiving the OFDM-based PBCH via a first set of transmission occasions; and receiving an OOK-based PBCH via a second set of transmission occasions.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 shows a diagram that depicts several details of the 5G SSB design.

FIG. 3 shows a simplified receiver architecture of a WTRU that utilizes a low-power wake-up receiver.

FIG. 4 shows a diagram that depicts a device that has no energy storage and no independent signal generation/amplification.

FIG. 5 shows a diagram that depicts a device that has energy storage, but has no independent signal generation (e.g., Device B may use backscattering transmission).

FIG. 6 shows a diagram that depicts a device that has both energy storage and independent signal generation.

FIG. 7 shows a diagram that depicts an idle mode wake-up signal in LTE Release 15.

FIG. 8 shows diagrams that compare WTRU power saving enhancements in idle and/or inactive modes.

FIG. 9 illustrates a diagram that depicts four example on/off patterns that may be used for an example modulation/length combination.

FIG. 10 illustrates a diagram that depicts first and second sets of transmission occasions, according to an example.

FIG. 11 illustrates a diagram that depicts example locations of SSSs and PBCHs based on a received PSS and/or a WTRU type and/or service type.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

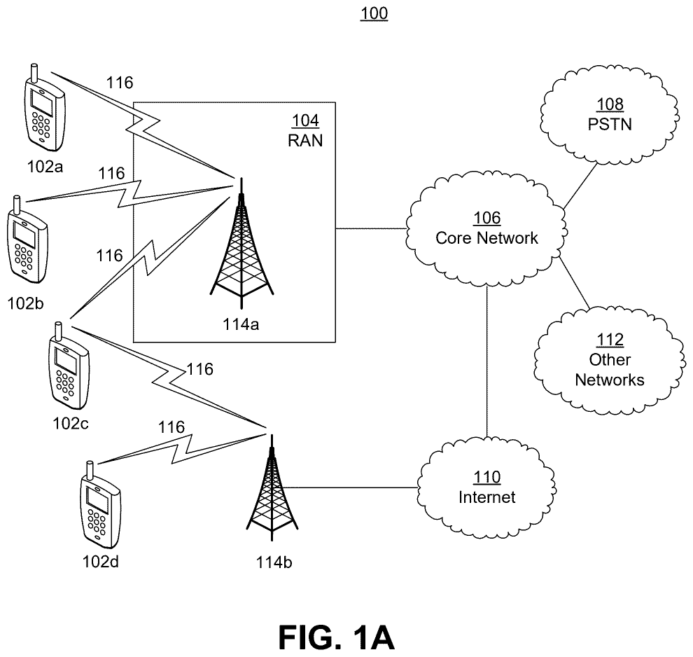

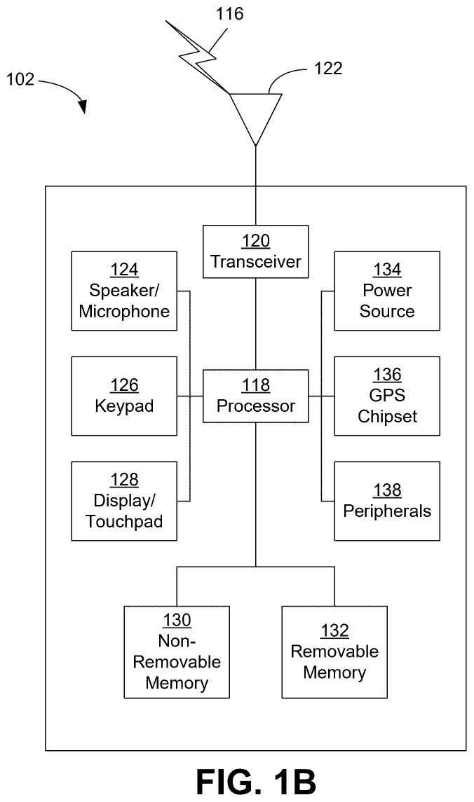

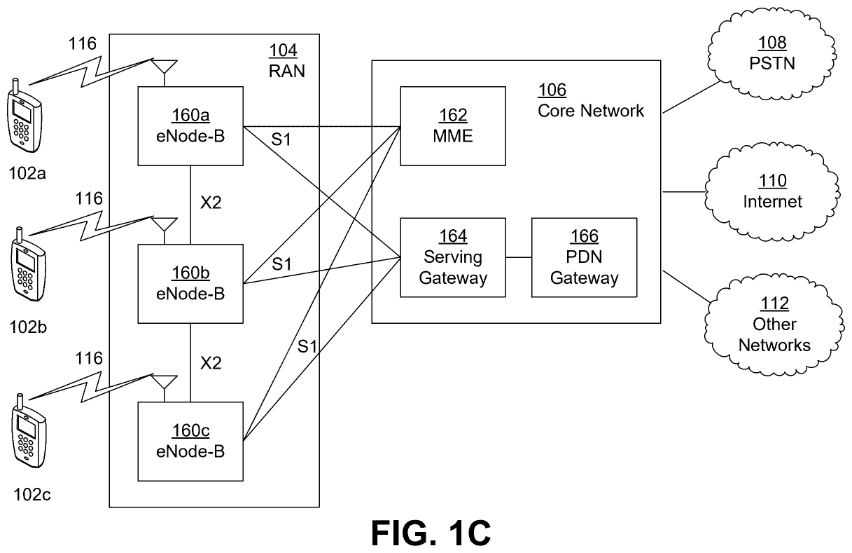

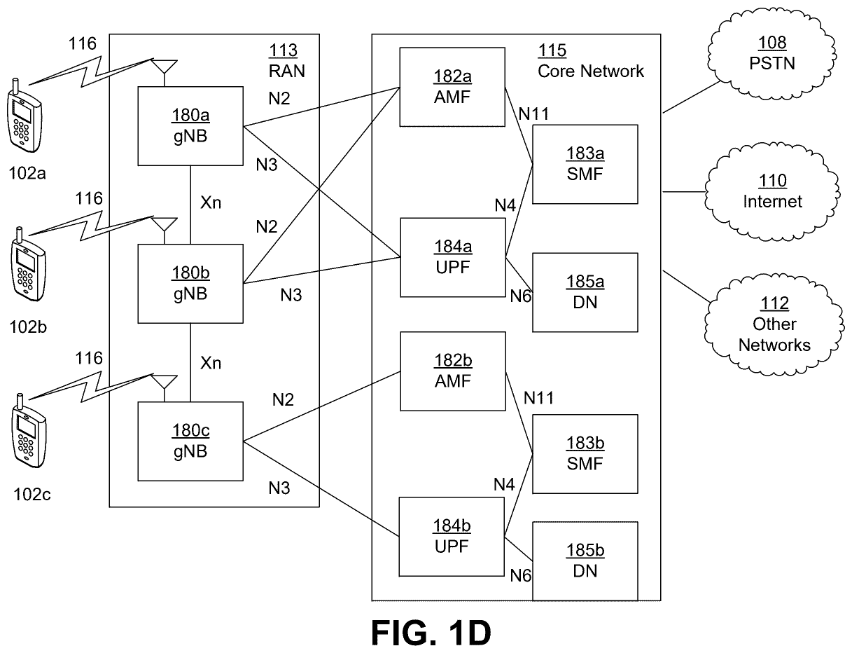

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a diagram illustrating an example communications system 100 in which one or more disclosed embodiments may be implemented. The communications system 100 may be a multiple access system that provides content, such as voice, data, video, messaging, broadcast, etc. to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received (e.g., as indicated by timing information) from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11 ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11 ah. The channel operating bandwidths, and carriers, are reduced in 802.11af and 802.11 ah relative to those used in 802.11n, and 802.11ac. 802.11af supports 5 MHz, 10 MHz and 20 MHz bandwidths in the TV White Space (TVWS) spectrum, and 802.11 ah supports 1 MHz, 2 MHz, 4 MHz, 8 MHz, and 16 MHz bandwidths using non-TVWS spectrum. According to a representative embodiment, 802.11 ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11 ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remain idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11 ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems and methods disclosed herein involve a common single synchronization signal block (SSB) for low-power radios (LRs) and main radios (MRs). In some examples, a wireless transmit/receive unit (WTRU) may determine an initial access procedure based on a WTRU capability and/or type. A different physical broadcast channel (PBCH) type may be used based on single synchronization signal block (SSB) group and/or index. The WTRU may determine PBCH and/or system information block (SIB) related information based on a detected on-off keying (OOK) pattern of synchronization signals. The OOK WTRU may request an on-demand PBCH after detecting synchronization signals. The WTRU may also determine the location of a secondary synchronization signal (SSS) based on WTRU type and/or service type.

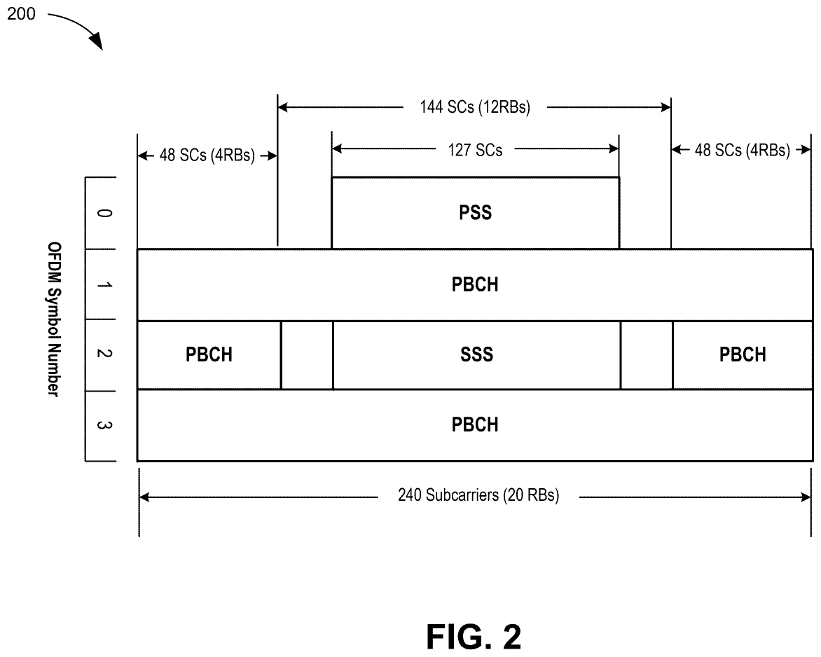

In Fifth Generation (5G) New Radio (NR), a single synchronization signal block (SSB) type has been defined and used. The SSB includes a primary synchronization signal (PSS), a secondary synchronization signal (SSS), and a physical broadcast channel (PBCH). Diagram 200 shown in FIG. 2 shows several details of the 5G SSB design.

For instance, as shown in diagram 200, the 5G SSB design includes 240 subcarriers (e.g., which may be equivalent to 20 resource blocks (RBs)). Note that one RB may include 12 subcarriers. In some examples herein, the term resource block (RB) may be used interchangeably with the term physical resource block (PRB).

As shown in diagram 200, synchronization signals (e.g., a primary synchronization signal (PSS) and a secondary synchronization signal (SSS)) may be located within 12 PRBs (e.g., including guard subcarriers).

The physical broadcast channel (PBCH) may be transmitted over 20 PRBs and located in each orthogonal frequency-division multiplexing (OFDM) symbol except for the first OFDM symbol.

Hereafter, “synchronization signal” may be interchangeably referred to as “sync signal,” “sync channel,” or “sync.”

A WTRU may scan synchronization rasters (e.g., where a “synchronization raster may refer to a set of time and/or frequency positions where a base station may transmit synchronization signals; the set of time and/or frequency positions may be specified by an industry standard) to detect the SSB in a certain frequency band or channel bandwidth. The synchronization raster may be located in the middle of a synchronization signal and/or subcarrier next to the middle of the synchronization signal. The reference frequency locations for synchronization rasters may be predefined per frequency range (e.g., Frequency Range 1 (FR1) and/or Frequency Range 2 (FR2)), frequency band (e.g., frequency band number), and/or channel bandwidth (e.g., carrier bandwidth within a frequency band), which may be a carrier bandwidth used by a network.

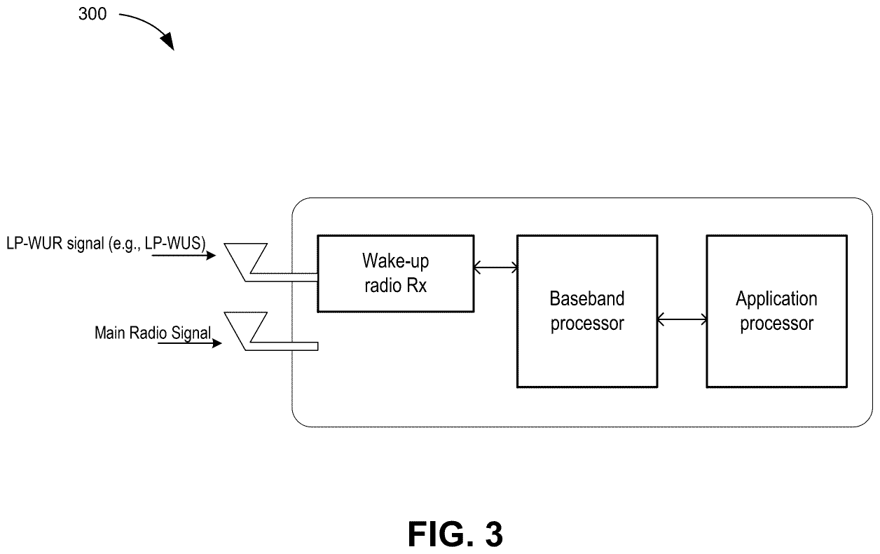

Low power-wake up signal (LP-WUS) monitoring has the potential to reduce power consumption of WTRUs and other small battery powered devices. This may be achieved by using a separate ultra-low power consumption receiver that can monitor wake-up signals (WUSs) and/or trigger the main radio (MR) dedicated for data and control signal transmission/reception as shown in FIG. 3 by the simplified receiver architecture 300 of a WTRU that utilizes a low-power wake-up receiver.

With respect to the Internet of Things (IoT), three device types have been identified.

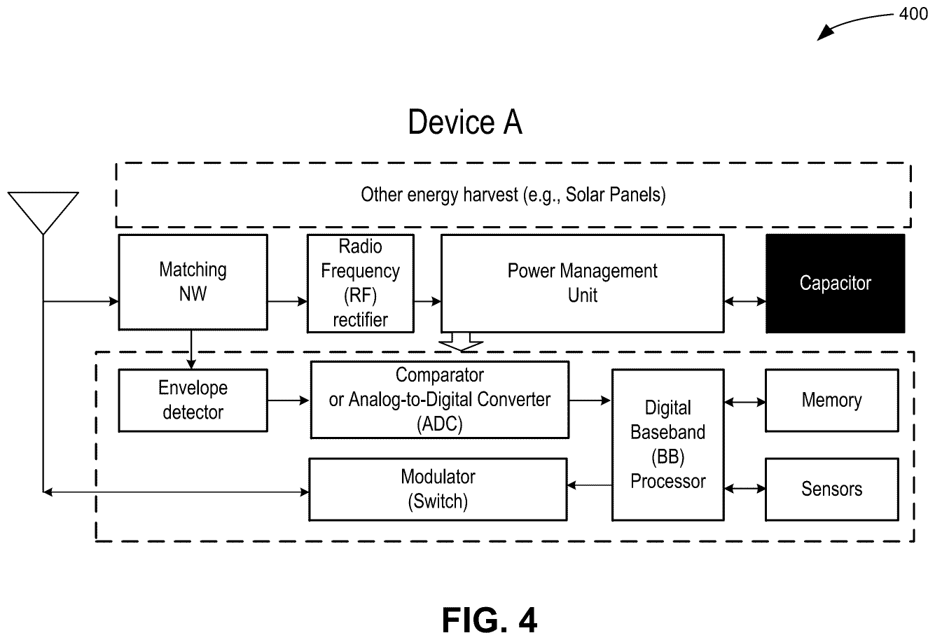

The first of these identified device types is depicted by diagram 400 in FIG. 4 (labeled as “Device A”). Device A has no energy storage and no independent signal generation/amplification (e.g., Device A may use backscattering transmission).

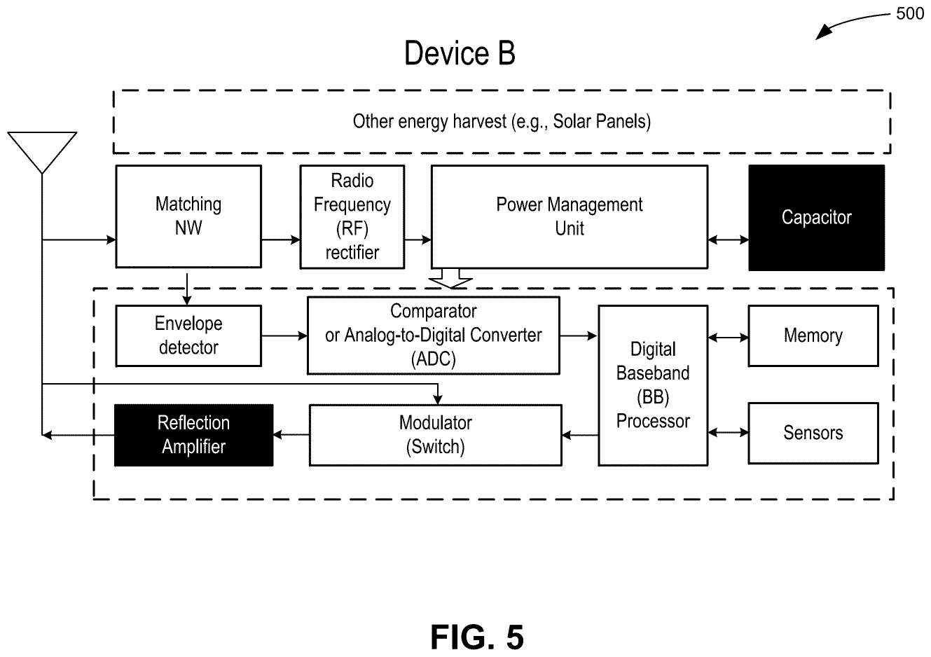

The second of these identified device types is depicted by the diagram 500 of FIG. 5 (labeled as “Device B”). Device B has energy storage, but has no independent signal generation (e.g., Device B may use backscattering transmission). Device B's use of stored energy may include amplification for reflected signals.

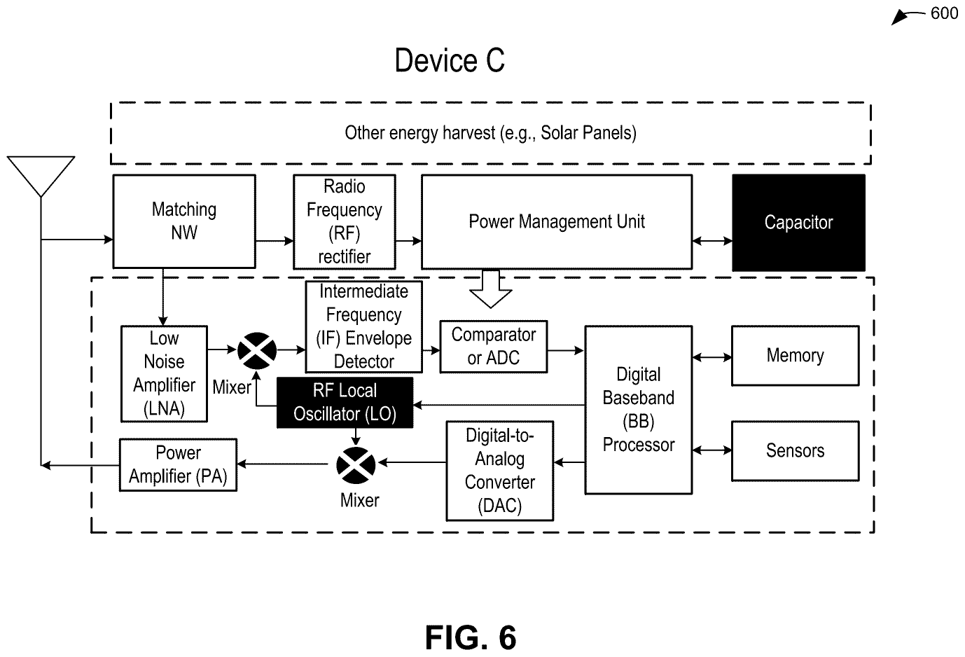

The third of these identified device types is depicted by the diagram 600 of FIG. 6 (labeled as “Device C”). Device C has both energy storage and independent signal generation (e.g., Device C has active radio frequency (RF) components for transmission).

For Device A, the architecture involved in backscattering may be similar to that of radio-frequency identification (RFID) devices (and/or may reuse RFID devices for evaluation). A capacitor (e.g., as shown in diagram 400) may still be used, as low level signals may not be able to power one or more components of Device A effectively during the reception phase.

With regard to backscattering, Device B may achieve better performance and larger coverage than Device A. Some differences of Device B as compared to Device A may include a power amplifier for transmission, a larger capacitor, and/or a power amplifier and/or reflection amplifier (e.g., as shown in the diagram 500) for reception (e.g., to increase the sensitivity).

For Device C (which may be associated with an active radio frequency (RF)), a Low-Power Wake-Up Signal (LP-WUS) Occasion (LO) and/or mixer may have to be used. If backscattering is supported, the corresponding architecture (e.g., indicated by the diagram 600) may be used.

In Release (Rel-19) of the 3rd Generation Partnership Project (3GPP), a low power synchronization signal (LP-SS) has been defined for LP-WUS operation of on-off keying (OOK)-based LRs as the OOK-based LRs are not able to detect/measure orthogonal frequency division multiplexing (OFDM)-based SSBs. The benefits of using an LP-SS may be at least two-fold. Firstly, a WTRU may acquire time and/or frequency synchronization so that the WTRU may receive a LP-WUS (e.g., from a Next generation Node B (gNB)). Secondly, the WTRU may measure channel quality, which may be used for various purposes (e.g., exit condition of LP-WUS monitoring, radio resource management (RRM) and/or radio link monitoring (RLM), etc.). However, supporting a dedicated and/or separate synchronization signal for an OOK-based LR involves a large signal overhead burden, especially considering that the synchronization signal may be on at all times.

For LP-WUS operation, a WTRU may have to have an LP-SS to have time and/or frequency synchronization for receiving an LP-WUS. With short periodicity, the WTRU may wake up quickly by achieving faster time and/or frequency synchronization. However, utilization of a low-periodicity LP-SS may involve much overhead. On the other hand, utilization of a high-periodicity LP-SS may involve low overhead, but may make wake-up latency larger. In addition, due to inefficient time and/or frequency synchronization, LP-WUS performance may be degraded.

Therefore, the problem of how a WTRU may efficiently support initial access based on a common synchronization signal for both LR and MR arises.

In some examples, systems and methods described herein may address this problem (and other problems). As described with respect to examples herein, common SSBs for both LR (e.g., OOK-based) and MR (e.g., OFDM-based) may be supported, where a WTRU may receive an OOK-based PBCH and an OFDM-based PBCH in a first set of SSBs and a second set of SSBs, respectively. If the WTRU receives the OOK-based PBCH (e.g., via an LR), the WTRU may support a simplified initial access procedure and a remaining initial access procedure after activating an MR. For instance, an example set of actions (e.g., steps) that the WTRU may perform are described below.

In an action (e.g., a first action), a WTRU may be turned on (e.g., may turn itself on) and the WTRU may determine a receiver type to be used for initial access.

For example, the WTRU may support performing (or attempting to perform) initial access with an LR (e.g., included in the WTRU) first and then perform initial access with an MR (e.g., included in the WTRU) if the LR-based attempt at initial access fails. In this example, some exception cases (e.g., specified by a configuration of the WTRU) may apply (e.g., transmission and/or reception with low latency data may be a possible exception).

In an action (e.g., a second action), if the WTRU has activated the MR, the WTRU may scan one or more SSBs over synchronization rasters until the WTRU receives a valid PSS and/or SSS of an SSB with one or more OOK-based ON/OFF patterns.

The WTRU may determine a cell identity (ID) based on the received PSS, SSS and/or ON/OFF pattern(s). For example, the WTRU may determine two bits from the PSS, seven bits from the SSS, and/or two bits from ON/OFF pattern(s).

The WTRU may receive an OFDM-based PBCH in a first set of transmission occasions (e.g., even numbered transmission occasions) based on at least the timing of the received PSS and/or SSS (e.g., as indicated by timing information).

The WTRU may receive an SIB (e.g., SIB1) based on the received PBCH.

The WTRU may transmit a message (e.g., Msg1) based on the received SIB.

In an action (e.g., a third action), if the WTRU activated the LR, the WTRU may scan one or more SSBs over synchronization rasters until the WTRU receives a valid ON/OFF pattern.

The WTRU may determine a part of a cell ID (e.g., two bits) based on the received ON/OFF pattern.

The WTRU may receive an OOK-based PBCH in a second set of transmission occasions (e.g., odd numbered transmission occasions) based on the part of cell ID and/or the received ON/OFF pattern (e.g., time offset from the ON/OFF pattern).

The WTRU may determine one or more uplink (UL) resources for transmitting a low-power preamble based on the received PBCH.

The WTRU may transmit the low-power preamble indicating a device type (e.g., whether the WTRU supports backscattering, sequence-based, and/or main radio) in the determined one or more UL resources.

The WTRU may receive a random access response (RAR) based on OOK indicating that the low-power preamble was received and/or indicating a time associated with the preamble transmission.

The WTRU may activate the MR (e.g., for data transmission/reception) (e.g., based on determining that a condition for determining whether to activate the MR is satisfied). The WTRU may request and/or perform a remaining procedure for initial access (e.g., connection set up) using the MR.

Systems and methods described herein may provide a number of advantages and/or benefits. For example, systems and methods described herein may reduce overhead for supporting separate synchronization signals for MR and LR. Furthermore, systems and methods described herein may facilitate additional WTRU power saving from initial access by using LR.

A WTRU may transmit or receive a physical channel or reference signal according to at least one spatial domain filter. The term “beam” may be used to refer to a spatial domain filter.

The WTRU may transmit a physical channel or signal using the same spatial domain filter as the spatial domain filter used for receiving a reference signal (RS) (such as a channel state information RS (CSI-RS)) or an SS block. The WTRU transmission may be referred to as a “target,” and the received RS and/or SS block may be referred to as a “reference” or “source.” In such a case, the WTRU may transmit the target physical channel and/or signal according to a spatial relation with a reference to such an RS and/or SS block.

The WTRU may transmit a first physical channel and/or signal according to the same spatial domain filter as the spatial domain filter used for transmitting a second physical channel and/or signal. The first and second transmissions may be referred to as a “target” and a “reference” (or “source”), respectively. In such a case, the WTRU may transmit the first (e.g., target) physical channel and/or signal according to a spatial relation with a reference to the second (e.g., reference) physical channel and/or signal.

A spatial relation may be implicit, configured by radio resource control (RRC) and/or signaled by MAC control element (CE) or downlink control information (DCI). For example, a WTRU may implicitly transmit a physical uplink shared channel (PUSCH) and/or a DM-RS of a physical uplink shared channel (PUSCH) according to the same spatial domain filter as a sounding reference signal (SRS) indicated by an SRS resource indicator (SRI) indicated in DCI or configured by RRC. In another example, a spatial relation may be configured by RRC for an SRI or signaled by a MAC CE for a physical uplink control channel (PUCCH). Such a spatial relation may also be referred to as a “beam indication.”

The WTRU may receive a first (e.g., target) downlink channel and/or signal according to the same spatial domain filter or spatial reception parameter as a second (reference) downlink channel and/or signal. For example, such an association may exist between a physical channel such as a physical downlink control channel (PDCCH) or a physical downlink shared channel (PDSCH) and the physical channel's respective demodulation reference signal (DM-RS). At least when the first and second signals are reference signals, such an association may exist when the WTRU is configured (e.g., via configuration information received from a base station) with a quasi-colocation (QCL) assumption type D between corresponding antenna ports. Such an association may be configured as a transmission configuration indicator (TCI) state. A WTRU may be indicated by an association between a CSI-RS and/or SS block and/or a DM-RS by an index to a set of TCI states configured by RRC and/or signaled by MAC CE. Such an indication may also be referred to as a “beam indication”.

The WTRU may use Discontinuous Reception (DRX) in an idle and/or inactive state (e.g., RRC_IDLE and/or RRC_INACTIVE) in order to reduce power consumption. The WTRU may monitor one paging occasion (PO) per DRX cycle. A PO may be a set of PDCCH monitoring occasions and may comprise multiple time slots (e.g. subframe and/or OFDM symbol) where paging DCI can be sent. One Paging Frame (PF) may be one Radio Frame and may contain one or multiple PO(s) and/or a starting point of a PO.

In multi-beam operations, the WTRU may assume that the same paging message and the same Short Message may be repeated in each transmitted beam and thus the selection of the beam(s) for the reception of the paging message and Short Message may be based on the type of the WTRU (e.g., the WTRU implementation). The paging message may be the same for both RAN-initiated paging and/or CN-initiated paging.

The WTRU may initiate a connection resume procedure (e.g., RRC Connection Resume procedure) in response to (e.g., upon and/or after) receiving RAN-initiated paging. If the WTRU receives a CN-initiated paging in an inactive state (e.g., RRC_INACTIVE), the WTRU may move to an idle state (e.g., RRC_IDLE) and may inform the non-access stratum (NAS).

When a search space identifier (e.g., SearchSpaceId) other than zero is configured for as paging search space (e.g., pagingSearchSpace), the WTRU may monitor the (i_s+1)^{th} PO (where i_s may represent an index of an SSB within a burst). A PO may be a set of ‘S·X’ consecutive PDCCH monitoring occasions where “S” may represent the number of actual transmitted SSBs determined according to the parameter ssb-PositionsinBurst in SIB1 and “X” may represent the parameter nrofPDCCH-MonitoringOccasionPerSSB-InPO (if configured) or may be equal to 1 otherwise. The [x*S+K]^{th} PDCCH monitoring occasion for paging in the PO may correspond to the K^{th} transmitted SSB, where x=0, 1, . . . , X−1, K=1, 2, . . . , S. The PDCCH monitoring occasions for paging which do not overlap with UL symbols (e.g., which may be determined according to the parameter tdd-UL-DL-ConfigurationCommon) may be sequentially numbered from zero starting from the first PDCCH monitoring occasion for paging in the paging frame (PF). When the parameter firstPDCCH-MonitoringOccasionOfPO is present, the starting PDCCH monitoring occasion number of the (i_s+1)^{th} PO may be the (i_s+1)^{th} value of the firstPDCCH-MonitoringOccasionOfPO parameter; otherwise, the starting PDCCH monitoring occasion number of the (i_s+1)^{th} PO may be equal to i_s*S*X. If X>1, when the WTRU detects a PDCCH transmission addressed to the paging radio network temporary identifier (P-RNTI) within a corresponding PO, the WTRU may not have to monitor the subsequent PDCCH monitoring occasions for this corresponding PO.

The following parameters may be used for the calculation of a PF and the parameter i_s which are mentioned above.

The parameter T may represent a DRX cycle of the WTRU. T may be determined based on (e.g., by) the shortest of the WTRU-specific DRX value(s), if configured by RRC and/or upper layers and/or based on a default DRX value broadcast in system information. In an idle state (e.g., RRC_IDLE), if WTRU-specific DRX is not configured by upper layers, the default DRX value may be applied).

The parameter N may represent a total number of paging frames in T.

The parameter Ns may represent a number of paging occasions for a PF.

The parameter PF_offset may represent an offset used for PF determination.

The parameter WTRU_ID may represent a temporary mobile subscriber identity (e.g., 5G-S-TMSI) mod 1024 (e.g., where “mod” may represent the modulus operator and there may be 1,024 possible paging groups).

The parameters Ns, nAndPagingFrameOffset, nrofPDCCH-MonitoringOccasionPerSSB-InPO, and the length of default DRX Cycle may be signaled in SIB1. The values of N and PF_offset may be derived from the parameter nAndPagingFrameOffset. The parameter first-PDCCH-MonitoringOccasionOfPO may be signaled in SIB1 for paging in an initial downlink (DL) bandwidth part (BWP). For paging in a DL BWP other than the initial DL BWP, the parameter first-PDCCH-MonitoringOccasionOfPO may be signaled in the corresponding BWP configuration (e.g., indicated via BWP configuration information).

If the WTRU has no TMSI (e.g., 5G-S-TMSI)—for instance, when the WTRU has not yet registered onto the network—the WTRU may use a default identity WTRU_ID=0 in the formulas that use PF and i_s above.

A WTRU may monitor for or listen to a paging message to know about one or more incoming calls, a system information change, an Earthquake and Tsunami Warning Service (ETWS) notification for ETWS-capable WTRUs, a Commercial Mobile Alert System (CMAS) notification, and/or an Extended Access Barring parameters modification.

In an idle state (e.g., RRC Idle), the WTRU may monitor Short Messages transmitted with a paging RNTI (P-RNTI) over DCI and may monitor a paging channel for CN paging using a TMSI (e.g., 5G-S-TMSI). In an inactive state (e.g., RRC Inactive), the WTRU may monitor Short Messages transmitted with a P-RNTI over DCI and may monitor a paging channel for CN paging using the TMSI (e.g., 5G-S-TMSI) and/or RAN paging using full-RNTI. In a connected state (e.g., RRC Connected state), a WTRU may monitor Short Messages transmitted with a P-RNTI over DCI.

A wake-up signal for idle mode paging may be used for WTRUs supporting NB-IoT or eMTC (e.g., in 3GPP Rel-15). Similar to the concept described above for connected mode, the WTRU monitors for a wake-up signal at a time specified by T_gap before the paging occasion. If the WTRU receives an indication that there may be paging addressed to that WTRU in the next paging time window then the WTRU monitors PDCCH during each paging occasion of that paging time window. The paging time window may be defined such that WTRUs with a very long DRX (e.g., in the order of minutes) (e.g., eDRX) and which may suffer from clock drift compared to the network timing may reliably receive paging.

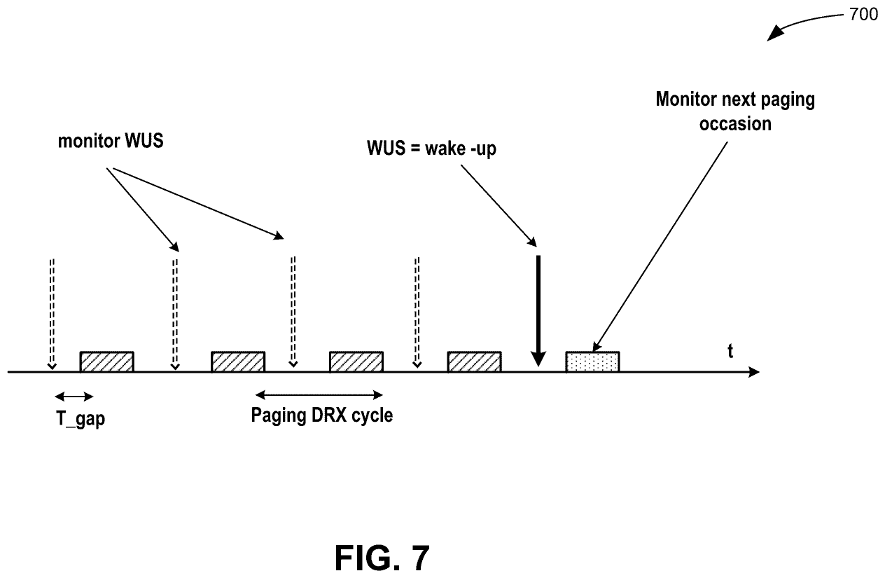

Referring to FIG. 7, a diagram 700 illustrates an example of an idle mode wake-up signal in LTE Release 15.

A wake-up signal for idle mode paging may be used in the examples described herein. A paging early indication (PEI) (e.g., in DCI format 2-7) transmitted prior to a WTRU paging occasion may indicate whether a WTRU has to monitor a PDCCH and/or potentially a PDSCH to receive a paging message. The PEI may also include a paging indication which may indicate WTRU subgroups in one or more paging occasions to be used for paging and/or may include a tracking reference system (TRS)-availability indication for acquiring time and/or frequency synchronization for paging.

A WTRU may wake up to measure an SS burst for time and/or frequency synchronization and/or to monitor paging occasions (POs). However, the WTRU may maintain a deep sleep (e.g., remain in a deep sleep state) if the WTRU does not receive a PEI. In addition, if the WTRU receives a PEI, the WTRU may wake up, measure a TRS burst, and receive POs. Another benefit of a PEI may be that the WTRU may not have to wake up periodically to maintain time and/or frequency synchronization for PO reception as the PEI may be able to indicate a TRS burst for acquiring time and/or frequency synchronization.

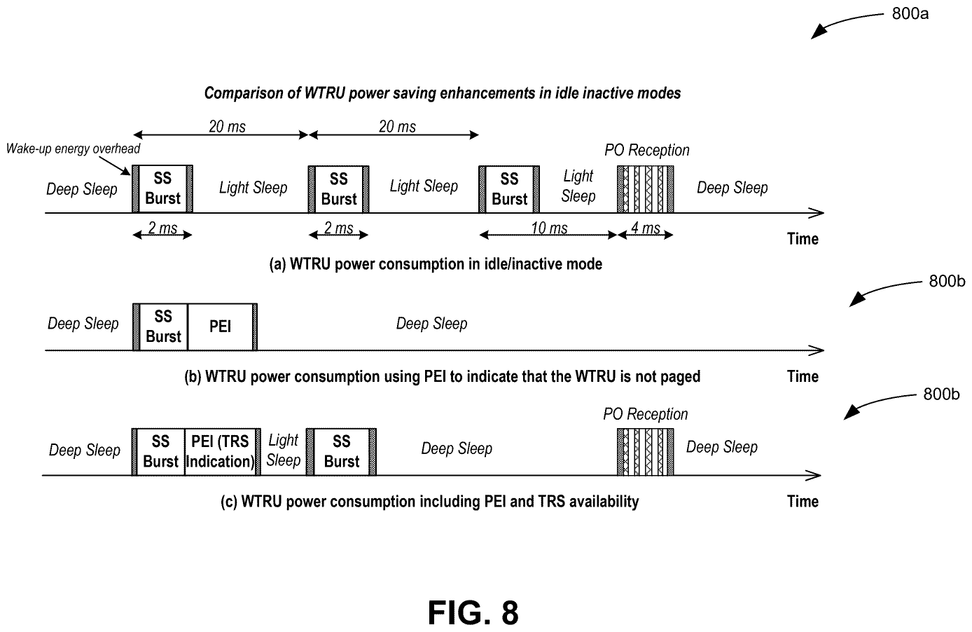

FIG. 8 shows diagrams 800a-c that compare WTRU power saving enhancements in idle and/or inactive modes. The diagram 800a depicts an example of WTRU power consumption without PEI. The diagram 800b depicts an example of WTRU power consumption using PEI to indicate that the WTRU is not paged. The diagram 800c depicts an example of WTRU power consumption using PEI and TRS availability.

Hereafter, the term “LP-WUS occasion” (“LO”) may be used interchangeably with the term “LP-WUS monitoring occasion” (“MO”).

In an example, a WTRU may receive configuration information (e.g., in one or more messages). The configuration information may be delivered via one or more of a SIB (e.g., SIB1), RRC, and/or a MAC CE. The configuration information may comprise one or more of the following types of information.

In an example, the WTRU may receive configuration information that comprises a WTRU ID. For example, a TMSI (e.g., 5G-S-TMSI) may be used as a WTRU ID.

The configuration information may comprise one or more paging-related configurations. For instance, the WTRU may receive configuration information that comprises an nAndPagingFrameOffset parameter. Based on the received configuration information (e.g., the nAndPagingFrameOffset parameter), the WTRU may determine one or more of the following types of information.

Based on the received configuration information (e.g., the nAndPagingFrameOffset parameter), the WTRU may receive and/or determine a total number of paging frames (e.g., represented by N). Candidate values for the total number of paging frames (e.g., number of total paging frames) may be different for different serving cells having different SSB periodicity.

Based on the received configuration information (e.g., the nAndPagingFrameOffset parameter), the WTRU may receive and/or determine a paging frame offset (e.g., represented by PF_offset).

The one or more paging-related configurations may comprise a DRX cycle (e.g., represented by T). In an example, the WTRU may receive information indicating a DRX cycle of the WTRU. T may be determined by the shortest of the WTRU specific DRX value(s) (e.g., if configured by RRC and/or upper layers) and/or by a default DRX value broadcast in system information. In an example, the WTRU may use a default value (e.g., in an idle state such as RRC_IDLE, if a WTRU-specific DRX is not configured by upper layers, the default value may be applied).

The one or more paging-related configurations may comprise a number of paging occasions (e.g., for a PF) (e.g., represented by Ns). For instance, in an example, the WTRU may receive information indicating number of paging occasions (e.g., per PF) for paging operation. For example, the WTRU may receive one of one, two, three, or four paging occasions for paging operation.

The configuration information may comprise PEI-related configurations.

The PEI-related configurations may comprise a search space set (e.g., represented by pei-SearchSpace). In an example, a WTRU may receive information indicating one or more search space sets (e.g., indicating the WTRU is to monitor a PDCCH for detection of DCI format 2_7 according to a Type2A-PDCCH common search space (CSS) set).

The PEI-related configurations may comprise a number of paging occasions in the PEI (e.g., represented by

$${N}_{PO}^{PEI}$$

and/or N_PO\hat{ }PEI). In an example, a WTRU may receive information indicating number of paging occasions supported by PEI. For example, one of 1, 2, 4 or 8 may be indicated.

The PEI-related configurations may comprise PEI payload size (e.g., represented by payloadSizeDCI-2-7). In an example, the WTRU may receive information indicating a PEI payload size. For example, up to 41 bits and 43 bits for licensed and unlicensed spectrums, respectively, may be indicated.

The PEI-related configurations may comprise a PEI frame offset (e.g., indicated by pei-FrameOffset). In an example, the WTRU may receive a frame offset for PEI. For example, the WTRU may receive an offset from the start of a reference frame for the PEI offset (PEI-O) (e.g., the start of a frame) to the start of a first paging frame of the paging frames associated with a number of PDCCH monitoring occasions (e.g., for DCI format 2_7).

The PEI-related configurations may comprise a PEI symbol offset (e.g., represented by firstPDCCH-MonitoringOccasionOfPEI-O). In an example, the WTRU may receive a symbol offset for PEI. For example, the WTRU may receive an offset (e.g., measured in a number of symbols) from the start of a frame to the start of a first PDCCH monitoring occasion (e.g., for DCI format 2_7).

The PEI-related configurations may comprise a number of subgroups (e.g., represented by

$${N}_{SG}^{PO}$$

and/or N_SG\hat{ }PO for PEI).

In an example, the WTRU may receive information indicating total number of subgroups (e.g., for PEI). For example, the WTRU may receive one or both of a parameter subgroupsNumPerPO and/or a parameter subgroupsNumForUEID. Based on the received information, the WTRU may determine whether to use WTRU-ID-based subgrouping or CN-based subgrouping. For example, one or more of the following approaches may be used.

An approach the WTRU may use to determine whether to use WTRU-ID-based subgrouping or CN-based subgrouping is as follows. If the parameter subgroupsNumForUEID is absent in a subgroup configuration (subgroupConfig), a subgroup ID based on a CN-assigned subgrouping, if available for the WTRU, may be used in a cell.

An approach the WTRU may use to determine whether to use WTRU-ID-based subgrouping or CN-based subgrouping is as follows. If both subgroupsNumPerPO and subgroupsNumForUEID are configured, and subgroupsNumForUEID has the same value as subgroupsNumPerPO, a subgroup ID based on WTRU-ID-based subgrouping may be used in the cell.

An approach the WTRU may use to determine whether to use WTRU-ID-based subgrouping or CN-based subgrouping is as follows, if both subgroupsNumPerPO and subgroupsNumForUEID are configured (e.g., indicated in configuration information), and subgroupsNumForUEID is less than subgroupsNumPerPO, a subgroup ID based on CN-assigned subgrouping, if available for the WTRU, may be used in the cell. Otherwise, a subgroup ID based on WTRU-ID-based subgrouping may be used in the cell.

If the WTRU has no CN-assigned subgroup ID or does not support CN-assigned subgrouping, and if there is no configuration for subgroupsNumForUEID, the WTRU may monitor an associated PO.

The configuration information may comprise configurations for LP-WUS. For instance, the configurations for LP-WUS may indicate LP-WUS occasions (LOs) and/or LP-WUS monitoring occasions (MOs).

In an example, the WTRU may receive configurations of LOs. For example, based on the configurations for LOs, the WTRU may receive configurations of N*K MOs (e.g., by receiving N*K sets of resources) for each LO, where N may be a number of beams corresponding to LP-WUS and K may be a number of LP-WUS MOs for each beam. The configuration of LOs (e.g., each LO) and/or MOs (e.g., each MO) may be based on one or more factors.

For instance, the configuration of LOs and/or MOs may comprise one or more of a sequence ID, a scrambling ID, and/or a cell ID. In an example, a WTRU may receive a configuration that indicates one or more of a sequence ID, a scrambling ID, and/or a cell ID. For example, the WTRU may receive an LP-WUS in an LP-WUS resource by using a sequence which may be generated by using the ID (e.g., sequence ID, scrambling ID, and/or cell ID) and/or data which may be scrambled by using the ID (e.g., in the time domain and/or the frequency domain).

The configuration of LOs and/or MOs may comprise a signal structure. In an example, the WTRU may receive a configuration that indicates a signal structure. For example, the WTRU may receive one or more of a support of preamble, a preamble length (if configured), a message type (e.g., sequence and/or encoded data), a number of repetition, etc.

The configuration of LOs and/or MOs may comprise a waveform. In an example, the WTRU may receive a configuration that indicates a waveform. For example, the WTRU may receive one or more of OOK-1, OOK-4, OFDMA, etc. as a waveform of LP-WUS. For OOK-4, M may be additionally configured (e.g., wherein M may represent a modulation scheme).

The configuration of LOs and/or MOs may comprise a monitoring type. In an example, the WTRU may receive a configuration that indicates a monitoring type. For example, the WTRU may receive an indication of one or more of continuous monitoring and/or duty-cycled monitoring.

The configuration of LOs and/or MOs may comprise frequency resources. In an example, the WTRU may receive a configuration that indicates frequency resources (e.g., absolute frequency resources). For example, the WTRU may receive a configuration based on one or more of RBs, sub-bands, BWPs, etc. to indicate frequency resources for receiving LP-WUS.

In an example, the WTRU may receive a configuration of relative time resources. For example, the WTRU may receive an indication of a frequency offset (e.g., measured in in RBs, sub-bands, and/or resource block groups (RBGs)) from one or more reference resources.

The configuration of LOs and/or MOs may comprise time resources. In an example, the WTRU may receive a configuration of time resources (e.g., absolute time resources). For example, the WTRU may receive a configuration based on one or more of periodicity, offsets, etc. The indication of this configuration may be based on OFDM symbols, us, slots, etc.

In an example, the WTRU may receive an implicit configuration of time resources. For example, the WTRU may receive a time offset (e.g., in symbols, subframes, and/or frames) from one or more reference resources.

The one or more reference resources may be one or more of the start of a frame, an associated paging frame, an associated paging occasion, one or more associated LOs (e.g., for MOs), an associated PEI search space, an SSB (PSS and/or SSS in NR-SS), LP-SS, etc.

The configurations for LP-WUS may comprise a number of subgroups (e.g., for LP-WUS operation or for each LP-WUS MO). In an example, the WTRU may receive information indicating a number of subgroups for LP-WUS. In an example, the number of subgroups may be a total number of subgroups for LP-WUS operation. In another example, the number of subgroups may be a number of subgroups supported by each LO and/or MO.

In another example, the WTRU may determine a number of subgroups based on received information. For example, the WTRU may use the number of subgroups for PEI as the number of subgroups for LP-WUS. In another example, the WTRU may determine the number of subgroups for LP-WUS as a scaling factor multiplied by the number of subgroups for PEI. The scaling factor may be indicated via one or more of an SIB, RRC and/or a MAC CE.

The configurations for LP-WUS may comprise a size of LP-WUS information. In an example, the WTRU may receive information indicating an LP-WUS payload size. For example, up to 8, 16, and/or 24 bits may be indicated as the LP-WUS payload size.

The WTRU may receive an indication of a size of LP-WUS information for each information type. For example, the WTRU may receive an indication of a first size of LP-WUS information for a first information type (e.g., for one or more of TRS availability indication, SI change, ETWS/CMAS information, etc.). The WTRU may receive an indication of a second size of LP-WUS information for a second information type (e.g., subgroup indication).

The configurations for LP-WUS may comprise an LP-WUS frame offset. In an example, the WTRU may receive a frame offset for LP-WUS. For example, the WTRU may receive an indication of an offset from the start of a reference frame for LP-WUS (e.g., the start of a frame) to the start of a first paging frame of the paging frames associated with LP-WUS monitoring for the WTRU.

The configurations for LP-WUS may comprise an LP-WUS symbol offset. In an example, the WTRU may receive an indication of a symbol offset for LP-WUS. For example, the WTRU may receive an indication of an offset (e.g., measured in a number of symbols) from the start of a frame to the start of a first LP-WUS monitoring occasion (e.g., for monitoring LP-WUS).

The configuration information may comprise a subgroup ID. In an example, the WTRU may receive an indication of a subgroup ID (e.g., for PEI and/or LP-WUS).

For example, the WTRU may receive subgroup ID(s) from an AMF via NAS signaling (e.g., in CN-based subgrouping). In another example, the WTRU may determine the subgroup ID based on the WTRU ID and a total number of subgroups for WTRU-ID-based subgrouping.

In an example, the WTRU may receive an indication of a subgroup ID for both PEI and LP-WUS). In another example, the WTRU may receive an indication of a first subgroup ID for PEI and an indication of a second subgroup ID for LP-WUS. In another example, the WTRU may receive an indication of a subgroup ID for PEI and determine a subgroup ID for LP-WUS based on the received information. In another example, the WTRU may determine subgroup IDs for PEI and LP-WUS, respectively, based on received information (e.g., a WTRU ID).

In an example, the WTRU may determine one or more POs associated with the WTRU. For example, the WTRU may determine one or more associated POs based on a WTRU ID. In an example, the WTRU may determine PO ID based on i_s (e.g., by determining a floor of quotient (WTRU-ID divided by N) mod Ns). In another example, the WTRU may use the equation

$$i\_PO = ( ( WTRU - ID mod N ) \cdot N\_S + i\_s ) mod {N}_{PP}^{PEI} .$$

In an example, a WTRU may determine (e.g., identify) one or more LOs associated with the WTRU. The WTRU may determine the one or more LOs associated with the WTRU based on WTRU ID, associated PO, and/or associated PF.

For example, the WTRU may determine the one or more LOs associated with the WTRU based on the WTRU ID. For example, an associated LO ID may be floor (UE_ID/N) mod N_LO wherein N_LO may be total number of LOs (e.g., for a PF).

### Associated PO

The WTRU may determine the one or more LOs associated with the WTRU based on determined POs. For example, an LO may be associated with each PO (e.g., based on a time and/or frequency offset). The WTRU may determine (e.g., identify) an LO which may be associated with a determined PO (e.g., based on the WTRU ID).

The WTRU may determine one or more associated PFs based on the WTRU ID. Based on the determined PFs, the WTRU may determine the one or more LOs associated with the WTRU. For example, an LO may be associated with each PF (e.g., based on a time and/or frequency offset). The WTRU may determine an LO which may be associated with a determined PF (e.g., based on the WTRU ID).

In an example, a WTRU may determine one or more MOs associated with the WTRU. The WTRU may determine the one or more MOs based on one or more of WTRU ID, associated PO, and/or associated PF.

For example, the WTRU may determine the one or more MOs associated with the WTRU based on the WTRU ID.

Based on a determined PO, the WTRU may determine the one or more MOs associated with the WTRU. For example, one or more MOs may be associated with each PO (e.g., based on a time and/or frequency offset). The WTRU may determine one or more MOs which may be associated with the determined PO (e.g., based on the WTRU ID).

Based on a determined LO, the WTRU may determine the one or more MOs associated with the WTRU. For example, a LO may be associated with each PO (e.g., based on time and/or frequency offset). The WTRU may determine one or more MOs which may be associated with the determined PO (e.g., based on the WTRU ID).

The WTRU may determine one or more associated PFs based on the WTRU ID. Based on the determined PFs, the WTRU may determine one or more MOs associated with the WTRU. For example, an MO may be associated with each PF (e.g., based on a time and/or frequency offset). The WTRU may determine an MO which may be associated with a determined PF (e.g., based on the WTRU ID).

In an example, a WTRU may determine LP-WUS information based on received information. For example, the WTRU may determine whether to split subgroup information into two or more LOs and/or MOs. For example, the WTRU may determine whether to split the subgroup information based on the size of LP-WUS information. For example, the WTRU may determine the number of subgroups based on the size of LP-WUS information (e.g., for subgroups) and/or the number of subgroups for LP-WUS. For example, if the size of LP-WUS information (e.g., for all LP-WUS and/or all subgroup information) is greater than or equal to a size (e.g., required size) of information for a number of subgroups (e.g., the number of all subgroups—e.g., for LP-WUS if bitmap is used), the WTRU may receive information that indicates subgroups (e.g., all subgroups) within one LO and/or MO of the LP-WUS that is associated with the WTRU. If the size of LP-WUS information (e.g., for all LP-WUS or all subgroup information) is less than the size (e.g., required size) of information for subgroups (e.g., the number of all subgroups—e.g., for LP-WUS if bitmap is used), the WTRU may receive information indicating the subgroups within two or more associated LOs and/or MOs.

Based on the determination (e.g., of LP-WUS information and location), the WTRU may split the subgroup information into two or more LOs and/or MOs. The split of the subgroup information may be based on one or more of a number of subgroups for each LO and/or MO, a number of associated LOs and/or MOs (e.g., associated with the WTRU), and/or a number of subgroups for PEI.

For example, the WTRU may receive an indication of a number of subgroups for each LO and/or MO (e.g., via one or more of a SIB, RRC, and/or a MAC CE). Based on the number of subgroups for each LO and/or MO, the WTRU may determine LOs or MOs indicating a set of subgroups. For example, if eight subgroups are supported and four subgroups for each MO may be indicated, then first-four subgroup information may be indicated in a first MO and second-four subgroup information may be indicated in a second MO.

For example, the WTRU may determine a number of subgroups for each LO and/or MO based on a number of associated LOs (e.g., per PO or paging frame—e.g., within a same beam) and/or POs (e.g., per LO, PO or paging frame—e.g., within a same beam). The WTRU may receive S subgroups in each MO, wherein S may be a total number of subgroups divided by K (e.g., where K represents a number of MOs within an LO with a same beam).

For example, the WTRU may receive an indication of a total number of subgroups for PEI (e.g., via one or more of an SIB, RRC, and/or a MAC CE). For example, the WTRU may receive an indication of the total number of subgroups for PEI in each LO and/or MO. For example, if eight subgroups are configured for PEI and sixteen subgroups are configured for LP-WUS, then a first MO may indicate a first-eight subgroup and a second MO may indicate a second-eight subgroup.

In an example, a WTRU may determine a subgroup ID of the WTRU for LP-WUS. The determination may be based on one or more of a same subgroup ID used for PEI, an indicated (e.g., received) subgroup ID for LP-WUS, and/or a determined subgroup ID for LP-WUS.

In an example, the WTRU may use a same subgroup ID used for PEI to determine a subgroup ID of the WTRU for LP-WUS. The same subgroup ID may be used if a number of subgroups for LP-WUS is the same as a number of subgroups for PEI (e.g., if the number of subgroups in LP-WUS equals the number of subgroups in PEI).

In an example, the WTRU may receive an indication of a subgroup ID for LP-WUS (e.g., via one or more of NAS signaling from an AMF, a SIB, RRC, and/or a MAC CE).

In an example, the WTRU may determine a subgroup ID for LP-WUS. For example, the WTRU may determine a WTRU subgroup ID for LP-WUS based on a WTRU subgroup ID for PEI. For example, if the number of subgroups in LP-WUS is greater than the number of subgroups in PEI, the WTRU subgroup ID in LP-WUS may be determined by evaluating the following expression: WTRU subgroup ID in PEI*number of subgroups in LP-WUS/number of subgroups in PEI (or indicated scaling factor)+mod(WTRU_ID, number of subgroup in LP-WUS/number of subgroup in PEI (or indicated scaling factor)). In this expression, “mod” may refer to the modulus function (e.g., mod(x,y) may, in some examples, be rewritten as x mod y).

In another example, if the number of subgroups in LP-WUS is less than the number of subgroups in PEI, the WTRU subgroup ID in LP-WUS may be determined by evaluating the following expression: floor (WTRU subgroup ID/number of subgroups in LP-WUS*number of subgroups in PEI). In this expression, “floor” may refer to the floor function.

In an example, the WTRU may determine LOs and/or MOs to be monitored for LP-WUS. The MOs and/or LOs to be monitored may be based on one or more of: all the LOs and/or MOs associated with the WTRU, the LOs and/or MOS associated with the WTRU's subgroup ID, and/or the LOs and/or MOs delivering common information.

For example, the WTRU may monitor LOs and/or MOs associated with the WTRU (e.g., all LOs and/or MOs associated with the WTRU) (e.g., based on WTRU ID and/or a PO associated with the WTRU ID).

For example, the WTRU may monitor LOs and/or MOs associated with the WTRU's subgroup ID (e.g., among the LOs and/or MOs associated with the WTRU ID and/or the associated PO).

For example, the WTRU may monitor LOs and/or MOs which indicate the determined WTRU's subgroup ID (e.g., only the LOs and/or MOs which indicate the determined WTRU's subgroup ID).

For example, the WTRU monitors LOs and/or MOs delivering common information. For example, the WTRU may monitor LOs and/or MOs delivering TRS availability information, SI change, ETWS/CMAS information, etc.

In an example, a WTRU may apply indicated information via LP-WUS if the WTRU detects LP-WUS in the determined LOs and/or MOs. For example, if the WTRU detects a change in system information (SI), the WTRU may apply an indicated set of system information. In an example, if the WTRU detects an SI change, the WTRU may activate an MR and/or receive updated system information. In an example, if the WTRU receives ETWS/CMAS information, the WTRU may apply indicated information (e.g., included therein). If the WTRU detects a TRS availability indication, the WTRU may use the indicated information (e.g., the TRS availability indication) to identify a TRS location for time and/or frequency synchronization when the WTRU monitors a PDCCH (e.g., after activation of the MR). In an example, if the WTRU detects LP-WUS indicating the WTRU's subgroup ID (e.g., for LP-WUS) in a received LP-WUS, the WTRU may monitor PEI and/or a PO associated with the WTRU. If the WTRU receives a paging message, the WTRU may respond (e.g., send a physical random access channel (PRACH)).

Hereafter, “initial access procedure” may be interchangeably used with “cell reselection procedure” without departing from the scope of this disclosure.

Hereafter, “PSS” may be interchangeably used with “synchronization signal,” “SSS,” and/or “Third Synchronization Signal” (“TSS”) without departing from the scope of this disclosure.

In an example, a WTRU may receive one or more synchronization signals with an ON/OFF pattern. For example, a location of synchronization signals (e.g., PSS and/or SSS) may be transmitted with an ON/OFF pattern. Each synchronization signal may be transmitted with a sequence. The sequence may be based on one or more of a Zadoff-Chu (ZC) sequence, a maximum-length sequence (e.g., M-sequence), a Gold sequence, a Chirp sequence, a Walsh sequence, a Golay sequence, a Kasami sequence, a low-density sequence, Discrete Fourier Transform (DFT) and/or Fast Fourier Transform (FFT) sequence, a Quadrature Amplitude Modulation (QAM)-symbol-based sequence, and/or a computer generated sequence.

The synchronization signal may be based on different combinations of modulation (M) (e.g., number of OOK symbols within one OFDM symbol in the time domain) and length (L). For example, combinations (M, L) for the synchronization signal may be one or more of (1, 4), (1, 6), (1, 8), (2, 8), (2, 12), (2, 16), (4, 16), and/or (4, 32).

In some examples described herein, an on/off pattern that is associated with an SSB may be a pattern that includes sequentially transmitted combinations of SSS transmissions and blanks (e.g., where a blank may refer to an absence of a transmission during a symbol).

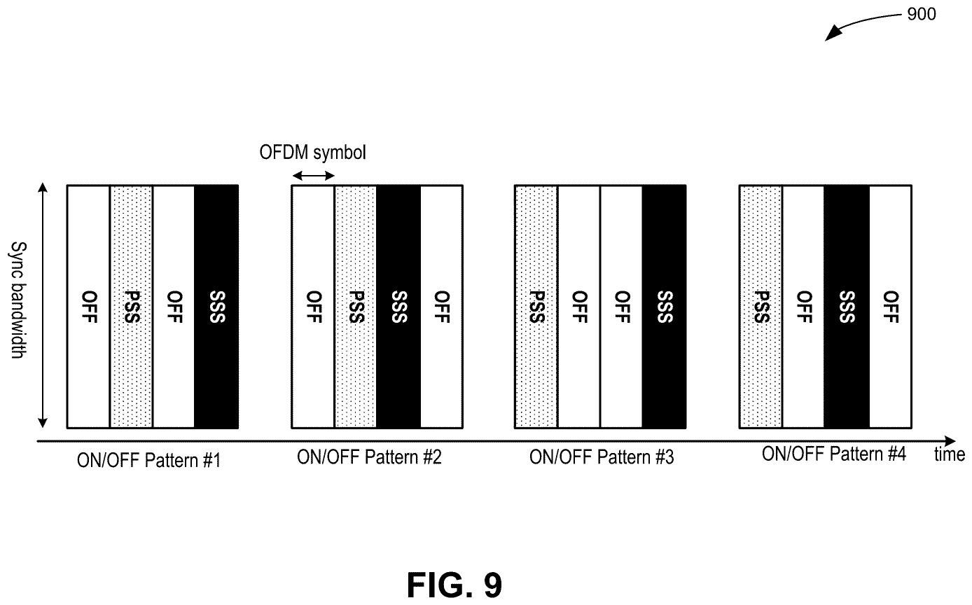

FIG. 9 illustrates a diagram 900 that depicts four example on/off patterns that may be used for the combination (1,4) (e.g., modulation=1 and length=4). As shown in the diagram 900, four patterns that may be used include “ON/OFF Pattern #1” ([0 PSS 0 SSS]), “ON/OFF Pattern #2” ([0 PSS SSS 0]), “ON/OFF Pattern #3” ([PSS 0 0 SSS]), and “ON/OFF Pattern #4” ([PSS 0 SSS 0]), where a value of “0” in an on/off pattern represents “OFF.”

The pattern [0 PSS 0 SSS](“ON/OFF Pattern #1”) refers to a sequence of four OFDM symbols in which no SS is transmitted during the first OFDM symbol, a PSS is transmitted during the second OFDM symbol, no SS is transmitted during the third OFDM symbol, and an SSS is transmitted during the fourth OFDM symbol.

The pattern [0 PSS SSS 0](“ON/OFF Pattern #2”) refers to a sequence of four OFDM symbols in which no SS is transmitted during the first OFDM symbol, a PSS is transmitted during the second OFDM symbol, an SSS is transmitted during the third OFDM symbol, and no SS is transmitted during the fourth OFDM symbol.

The pattern [PSS 0 0 SSS](“ON/OFF Pattern #3”) refers to a sequence of four OFDM symbols in which a PSS is transmitted during the first OFDM symbol, no SS is transmitted during the second OFDM symbol, no SS is transmitted during the third OFDM symbol, and an SSS is transmitted during the fourth OFDM symbol.

The pattern [PSS 0 SSS 0](“ON/OFF Pattern #4”) refers to a sequence of four OFDM symbols in which a PSS is transmitted during the first OFDM symbol, no SS is transmitted during the second OFDM symbol, an SSS is transmitted during the third OFDM symbol, and no SS is transmitted during the fourth OFDM symbol.

In an example, the combination of modulation and length may be (1,6) (e.g., modulation=1 and length=6). In this example, four patterns that may be used include [PSS 0 SSS #1 0 SSS #2 0], [0 PSS 0 SSS #1 0 SSS #2], [PSS 0 0 SSS #1 0 SSS #2], and [PSS 0 SSS #1 0 0 SSS #2].

In an example, the combination of modulation and length may be (1, 8) (e.g., modulation=1 and length=8). In this example, four patterns that may be used include [PSS 0 SSS 0 0 PSS 0 SSS], [PSS 0 SSS 0 PSS 0 0 SSS], [PSS 0 0 SSS 0 PSS 0 SSS], and [0 PSS 0 SSS 0 PSS 0 SSS].

In an example, the combination of modulation and length may be (2, 8) (e.g., modulation=2 and length=8). In this example, four patterns that may be used include [0 PSS 0 SSS PSS 0 0 SSS], [0 PSS SSS 0 0 PSS 0 SSS], [0 PSS SSS 0 PSS 0 0 SSS], and [PSS 0 0 SSS 0 PSS SSS 0].

In an example, the combination of modulation and length may be (2, 12) (e.g., modulation=2 and length=12). In this example, four patterns that may be used include [PSS 0 0 SSS #1 SSS #2 0 0 PSS SSS #1 0 0 SSS #2], [0 PSS SSS #1 0 SSS #2 0 0 PSS SSS #1 0 0 SSS #2], [0 PSS SSS #1 0 0 SSS #2 PSS 0 SSS #1 0 0 SSS #2], and [0 PSS SSS #1 0 0 SSS #2 0 PSS SSS #1 0 0 SSS #2].

In an example, the combination of modulation and length may be (4, 16) (e.g., modulation=4 and length=16). In this example, a first set of four patterns that may be used includes [0 PSS SSS #1 0 PSS 0 0 SSS PSS 0 SSS 0 PSS 0 SSS 0], [0 PSS SSS 0 PSS 0 SSS 0 PSS 0 0 SSS PSS 0 SSS 0], [PSS 0 SSS 0 0 PSS SSS 0 PSS 0 SSS 0 PSS 0 0 SSS], and [PSS 0 SSS 0 PSS 0 0 SSS PSS 0 SSS 0 0 PSS SSS 0].

In this example, a second set of four patterns that may be used includes [PSS 0 0 0 SSS 0 0 0 0 0 0 PSS 0 0 SSS 0], [PSS 0 0 0 0 SSS 0 0 PSS 0 0 0 0 0 SSS 0], [PSS 0 0 0 0 SSS 0 0 0 PSS 0 0 SSS 0 0 0], and [PSS 0 0 0 0 SSS 0 0 0 0 0 PSS 0 0 0 SSS].

In an example, the combination of modulation and length may be (4, 32) (e.g., modulation=4 and length=32). In this example, a first set of four patterns that may be used includes [0 PSS 0 SSS PSS 0 SSS 0 PSS 0 SSS 0 PSS 0 0 SSS PSS 0 SSS 0 0 PSS SSS 0 0 PSS SSS 0 0 PSS 0 SSS], [0 PSS SSS 0 0 PSS 0 SSS 0 PSS SSS 0 0 PSS 0 SSS PSS 0 0 SSS PSS 0 SSS 0 PSS 0 SSS 0 0 PSS 0 SSS], [0 PSS 0 SSS 0 PSS 0 SSS PSS 0 SSS 0 PSS 0 0 SSS PSS 0 SSS 0 PSS 0 0 SSS PSS 0 SSS 0 0 PSS SSS 0], and [0 PSS 0 SSS 0 PSS SSS 0 0 PSS 0 SSS PSS 0 SSS 0 0 PSS SSS 0 0 PSS SSS 0 PSS 0 SSS 0 0 PSS 0 SSS].

In this example, a second set of four patterns that may be used includes [0 0 0 PSS SSS 0 0 0 0 0 0 PSS 0 0 0 SSS PSS 0 0 0 0 0 0 SSS 0 0 0 PSS 0 SSS 0 0], [0 0 0 PSS 0 SSS 0 0 PSS 0 0 0 SSS 0 0 0 0 PSS 0 0 0 SSS 0 0 0 0 0 PSS 0 SSS 0 0], [0 0 PSS 0 0 0 SSS 0 PSS 0 0 0 0 SSS 0 0 PSS 0 0 0 0 0 0 SS 0 0 PSS 0 0 0 SSS 0], and [0 0 PSS 0 0 SSS 0 0 0 0 0 PSS SSS 0 0 0 0 0 PSS 0 SSS 0 0 0 0 PSS 0 0 0 0 SSS 0].

In the examples above, “SSS #2” may represent a third synchronization signal (TSS).

In an example, a WTRU may receive an indication based on synchronization signals (e.g., PSS and/or SSS) and/or an ON/OFF pattern. For example, the WTRU may receive an indications of one or more of a cell ID, a PBCH location, an SSB set index, a UL resource to request a PBCH, a PDCCH configuration (e.g., including CORESET0/SearchSpace0 time/frequency location), and/or cell barring information.

In an example, the WTRU may identify a cell ID based on received synchronization signals and ON/OFF pattern. For example, the WTRU may use the following equation:

$${N}_{ID}^{cell} = {N}_{PSS} {N}_{ID}^{( 1 )} + {N}_{SSS} {N}_{ID}^{( 2 )} + {N}_{ID}^{( 3 )} , where {N}_{ID}^{( 1 )}$$

may be indicated by receiving a PSS,

$${N}_{ID}^{( 2 )}$$

may be indicated by receiving an SSS, and

$${N}_{ID}^{( 3 )}$$

may be indicated by receiving an on/off pattern. Furthermore, N_{PSS} may represent a number of PSS IDs (e.g., three) and N_{SSS} may represent a number of SSS IDs.

In an example, the WTRU may identify PBCH location (e.g., time and frequency resources) based on one or more synchronization signals and an on/off pattern.

In an example, a first PBCH location may be associated with a first on/off pattern, a second PBCH location may be associated with a second on/off pattern, a third PBCH location may be associated with a third on/off patten, and a fourth PBCH location may be associated with a fourth on/off patten.

In an example, the WTRU may identify an SSB set index based on one or more synchronization signals and/or on/off pattern.

In an example, a first SSB set index (e.g., SSB set #0) may be associated with a first on/off pattern and a second SSB set index (e.g., SSB set #1) may be associated with a second on/off pattern.

In an example, the WTRU may identify one or more UL resources to request PBCH. Based on received information, the WTRU may transmit one or more UL signals and receive a PBCH (e.g., in one or more associated DL resources).

In an example, the WTRU may identify a PDCCH configuration including a CORESET0 time and/or frequency location. Based on received information, the WTRU may receive a PDCCH (e.g., scheduling system information, random access response, etc.).

In an example, the WTRU may identify whether a cell is barred or not. Based on received information, the WTRU may determine whether to continue an initial access procedure (e.g., if the cell is not barred) or not (e.g., if the cell is barred).

An example set of actions (e.g., steps) that the WTRU may perform are described below.

In an action (e.g., a first action), a WTRU may be turned on (e.g., may turn itself on) and the WTRU may determine a receiver type to be used for initial access.

For example, the WTRU may support performing (or attempting to perform) initial access with an LR (e.g., included in the WTRU) first and then perform initial access with an MR (e.g., included in the WTRU) if the LR-based attempt at initial access fails. In this example, some exception cases (e.g., specified by a configuration of the WTRU) may apply (e.g., transmission and/or reception with low latency data may be a possible exception).

In an action (e.g., a second action), if the WTRU has activated the MR, the WTRU may scan one or more SSBs over synchronization rasters until the WTRU receives a valid PSS and/or SSS of an SSB with one or more OOK-based ON/OFF patterns.

The WTRU may determine a cell identity (ID) based on the received PSS, SSS and/or ON/OFF pattern(s). For example, the WTRU may determine two bits from the PSS, seven bits from the SSS, and/or two bits from ON/OFF pattern(s).

The WTRU may receive an OFDM-based PBCH in a first set of transmission occasions (e.g., even numbered transmission occasions) based on at least the timing of the received PSS and/or SSS (e.g., as indicated by timing information).

The WTRU may receive an SIB (e.g., SIB1) based on the received PBCH.

The WTRU may transmit a message (e.g., Msg1) based on the received SIB.

In an action (e.g., a third action), if the WTRU activated the LR, the WTRU may scan one or more SSBs over synchronization rasters until the WTRU receives a valid ON/OFF pattern.

The WTRU may determine a part of a cell ID (e.g., two bits) based on the received ON/OFF pattern.

The WTRU may receive an OOK-based PBCH in a second set of transmission occasions (e.g., odd numbered transmission occasions) based on the part of cell ID and/or the received ON/OFF pattern (e.g., time offset from the ON/OFF pattern).

The WTRU may determine one or more uplink (UL) resources for transmitting a low-power preamble based on the received PBCH.

The WTRU may transmit the low-power preamble indicating a device type (e.g., whether the WTRU supports backscattering, sequence-based, and/or main radio) in the determined one or more UL resources.

The WTRU may receive a random access response (RAR) based on OOK indicating that the low-power preamble was received and/or indicating a time associated with the preamble transmission.

The WTRU may activate the MR (e.g., for data transmission/reception) (e.g., based on determining that a condition for determining whether to activate the MR is satisfied). The WTRU may request and/or perform a remaining procedure for initial access (e.g., connection set up) using the MR.

A WTRU may receive, identify, and/or be configured with one or more types of configuration information associated with a random access procedure. The WTRU may receive the configuration information, for example via RRC, a MAC-CE, DCI, an SIB, etc. For example, the WTRU may receive one or more higher-layer parameters (e.g., prach-ConfigurationIndex by msgA-PRACH-ConfigurationIndex) if configured. These parameters may indicate a PRACH configuration index with respect to one or more configuration tables that include random access parameters. The configuration information associated with random access may include one or more of preamble format; frame number, subframe number, and/or slot number; starting symbol; number of PRACH slots within a 60 kHz slot; number of time-domain PRACH occasions within a PRACH slot; PRACH duration; msg1-FrequencyStart and/or msgA-RO-FrequencyStart; msg1-FDM and/or msgA-RO-FDM; preamble received target power; RSRP threshold for repetition number X of Msg1 and/or MsgA; power ramping step (e.g., powerRampingStep, msgA-PreamblePowerRampingStep, powerRampingStepHighPriority); and/or Maximum number of preamble transmission (e.g., preambleTransMax, preambleTransMax-Msg1-Repetition, msgA-TransMax, etc.).

In an example, the WTRU may be configured with a preamble format that may refer to one or more possible formats, such as A1, A2, A3, B1, A1/B1, A2/B2, A3/B3, B4, C0, and/or C2. The preamble format may identify a corresponding Cyclic Prefix (CP) duration, a sequence part duration, a guard time duration (if applicable), etc.

In an example, the WTRU may be configured with time-domain allocations, a subframe number, and/or slot numbers during which random access occasions (ROs) may be configured. Using one or more of these parameters, the WTRU may determine an RO slot (e.g., within a corresponding subframe), where the WTRU may transmit the configured PRACH in one or more of the determined ROs.

In an example, the WTRU may determine a symbol-level index corresponding to a starting position of a first RO transmission within an indicated and/or configured RO slot.

In an example, the WTRU may be indicated with a number of PRACH slots within a reference 60 kHz slot. In an example, the WTRU may be configured with a number of PRACH slots for high subcarrier spacing (SCS) values such as 120 kHz, 480 kHz, 960 kHz, etc., where the WTRU may treat the 60 kHz PRACH slot as a reference slot.

Number of time-domain PRACH occasions within a PRACH slot (e.g., depicted by

$$( {N}_{t}^{RA , slot} ) .$$

For example, the WTRU may be configured with a number of consecutive ROs that are located within a PRACH slot in the time domain.

In an example, the WTRU may be configured with the duration of an RO in a number of symbols.

In an example, parameters msg1-FrequencyStart and/or msgA-RO-FrequencyStart, if configured, may indicate an offset of a lowest PRACH transmission occasion in the frequency domain with respect to a PRB zero.

In an example, parameters msg1-FDM and/or or msgA-RO-FDM, if configured, may indicate a number of PRACH transmission occasions that may be frequency-division multiplexed (FDMed) in one time-domain RO.

The WTRU may receive, identify, and/or be configured with the number of ROs in frequency domain (M) per each time-domain PRACH occasion based on the higher layer parameters msg1-FDM, msg1-FDM-16, and/or msgA-RO-FDM, if configured, where msg1-FDM may have one or more of the values {one, two, four, eight}.

The WTRU may number the PRACH frequency resources nRA={0, 1, . . . , M−1}, starting from a lowest frequency, in increasing order in an initial uplink BWP during an initial access and/or an active uplink BWP otherwise.

In an example, the WTRU may receive an initial random access preamble power for the transmission of Msg 1 or Msg A.

In an example, the WTRU may receive a configuration on an RSRP threshold. Based on this received configuration, the WTRU may determine to perform a PRACH preamble repetition for X times (where X is a non-negative integer). In an example, if the WTRU determines that a measured DL pathloss reference signal received power (RSRP) is lower than a received threshold for a particular repetition number X, the WTRU may perform a PRACH repetition X times.

In an example, the WTRU may use a configured with power ramping step for increasing a PRACH transmission power up to a configured maximum number of times (e.g., preambleTransMax) or until A RAR is received.

In an example, the WTRU may be configured with a maximum number of Random Access Preamble transmissions (e.g., Y). The WTRU may increase the UL transmission power at each PRACH transmission occasion based on a power ramping step (powerRampingStep). In an example, a WTRU that is configured with a repetition number X may perform PRACH repetitions for X times, where the WTRU may transmit each repetition up to Y times (e.g., where Y represents a configured maximum number of allowed preamble transmission times, such as preambleTransMax-Msg1-Repetition). The WTRU may stop PRACH transmission if an RAR is received. If an RAR is not received and/or the maximum number of preamble transmission is reached, the WTRU may switch to repetition with a next available higher repetition number.

In an example, a WTRU may determine, be configured with, and/or receive an indication of one or more receiver types. The WTRU may determine a receiver type to be used for one or more operations. The WTRU may determine the receiver type based on one or more conditions, events, threshold values, etc. In an example, the WTRU may be configured (e.g., preconfigured) and/or receive configuration information and/or indications regarding the receiver type to be used. In an example, the configuration information may include an indication of the receiver type to be used. In another example, the configuration information may include indications of one or more threshold values, events, and/or conditions. The WTRU may receive the configuration information and/or indications, for example from a base station (e.g., via SIB, RRC, MAC-CE, DCI, etc.).

In an example, a WTRU may have, include, use, and/or contain one or more receiver types. For example, the WTRU may include a first receiver type, a second receiver type, and so forth. In an example, the first receiver type may be an LR, the second receiver type may be an MR, and so forth. In an example, the WTRU may determine, be configured with, and/or receive an indication of a receiver type to be used for initial access and/or a random-access procedure.

In an example, a WTRU may be configured with joint or separate sets of random access configurations for initial access based on different receiver types. In an example, the WTRU may be configured to use the same RACH configuration for initial access based on a first receiver type and a second receiver type. In another example, the WTRU may be configured with separate sets of RACH configurations for different receiver types. For example, the WTRU may be configured with a first set of RACH configurations if the WTRU uses the first receiver type and a second set of RACH configurations if the WTRU uses the second receiver type. In an example, a first PRACH UL power, a power ramping step, a maximum number of preamble transmissions, a maximum PRACH UL power, etc. configured based on the first set of RACH configurations may be lower than the second configured parameters based on the second set of RACH configurations.

In an example, for a random-access procedure based on MR, the WTRU may receive configuration information comprising one or more indications of an SSB pattern, SSB bursts, a number of transmitted SSBs, RACH configurations, and so forth. The RACH configurations may indicate the time and/or frequency resources for sending PRACH preambles, repetition configurations and/or threshold values, PRACH UL power configurations, a power ramping step, a PRACH maximum power, etc. The WTRU may receive the configuration information via RRC, MAC-CE, DCI, SIB, etc.

In an example, for a random-access procedure based on LR, a WTRU may receive configuration information comprising one or more valid on/off patterns with respect to a SSB. In addition, the WTRU may receive configuration information indicating the time and frequency resources to receive a PBCH, low power preambles, the time and frequency resources for the transmission of a low-power preamble, repetition parameters and/or threshold values, low-power preamble UL power parameters, a power ramping step, a number of re-attempts, a maximum UL power, etc. The WTRU may receive the configuration information via RRC, MAC-CE, DCI, SIB, PBCH, etc.

In an example, the WTRU may determine a receiver type to be used based on one or more of an Initial, primary, and/or prioritized receiver type and/or a mode of operation.

In an example, the WTRU may receive an indication of the receiver type to be used on a first attempt for monitoring, detecting, receiving, and/or measuring SSBs. In an example, the WTRU may determine and/or be configured to (e.g., prioritize to) use a first receiver type (e.g., LR) initially and then switch to a second receiver type (e.g., MR) if one or more conditions apply. In another example, the WTRU may determine and/or be configured to (e.g., prioritize to) use the second receiver type (e.g., MR) first and then switch to the first receiver type (e.g., LR) if one or more conditions apply.

In an example, the WTRU may be (pre)configured, indicated, determine, and/or receive an indication of the receiver type to be used based on the mode of operation. One or more of the following may apply: low latency, low power, cross-carrier operation, and/or coupled or decoupled UL/DL.

In an example, if the WTRU's operation is based on transmission and/or reception with low power, the WTRU may determine and/or be configured to use a first receiver type (e.g., LR).

In another example, if the WTRU's operation is based on transmission and/or reception with low latency data, the WTRU may determine and/or be configured to use a second receiver type (e.g., MR).

In another example, the WTRU may determine the receiver type to be used based on cross-carrier operations. For example, if the received SSB and the configured ROs are in the same carrier, the WTRU may use the first receiver type (e.g., LR). In another example, if the received SSB and the configured ROs are in different carriers, BWPs, etc., the WTRU may use the second receiver type (e.g., MR).

In an example, the WTRU may determine the receiver type to be used based on UL/DL beam correspondence. In an example, if there is a coupled relation between the UL and DL (e.g., beam correspondence), the WTRU may use a first receiver type (e.g., LR). In another example, if the UL and DL are decoupled, the WTRU may use a second receiver type (e.g., MR).

In an example, a WTRU may determine, be configured to, and/or receive an indication to switch from using a first receiver type to using a second receiver type based on one or more conditions. In an example, the WTRU may determine and/or be configured to use a first receiver type (e.g., LR) for an initial attempt during an initial access procedure. The WTRU may perform the initial access procedure based on the first receiver type until one or more of the determined and/or configured conditions are satisfied. For example, one or more of the conditions may apply (e.g., conditions based on re-attempting initial access for a number of times and/or a PRACH UL maximum power.

In an example, a condition for the WTRU to switch from using a first receiver type to using a second receiver type may be for the WTRU to re-attempt initial access for a number of times. The WTRU may use a first receiver type for performing an initial access for a determined and/or configured number of times. If the initial access is unsuccessful (e.g., a RAR is not received within a configured RAR window) after the configured number re-attempts, then the WTRU may switch to use a second receiver type. In an example, the WTRU may determine the number of re-attempts based on a configured maximum number of preamble transmissions (e.g., preambleTransMax, preambleTransMax-Msg1-Repetition, msgA-TransMax, etc.). In another example, the WTRU may determine, receive, and/or be configured with a separate configured value for the number of time to re-attempt the initial access.

In an example, a condition for the WTRU to switch from using a first receiver type to using a second receiver type may be based on a PRACH UL maximum power (e.g., Pc_Max). The WTRU may use a first receiver type for performing the initial access. The WTRU may perform power ramping for each re-attempt if the initial access is unsuccessful (e.g., if an RAR is not received within a configured RAR window). The WTRU may perform re-attempts and corresponding power ramping until a calculated PRACH UL power reaches the PRACH UL maximum power (e.g., Pc_Max). If the evaluated PRACH UL power reaches or exceeds the configured PRACH UL maximum power, the WTRU may switch to use a second receiver type.

In an example, a WTRU may determine a set of transmission occasions for receiving a PBCH (e.g., based on a determined receiver type). For example, if the WTRU uses and/or activates a second receiver type (e.g., MR), the WTRU may receive the PBCH in a first set of transmission occasions. If the WTRU uses and/or activates the first receiver type (e.g., LR), the WTRU may receive the PBCH in a second set of transmission occasions.

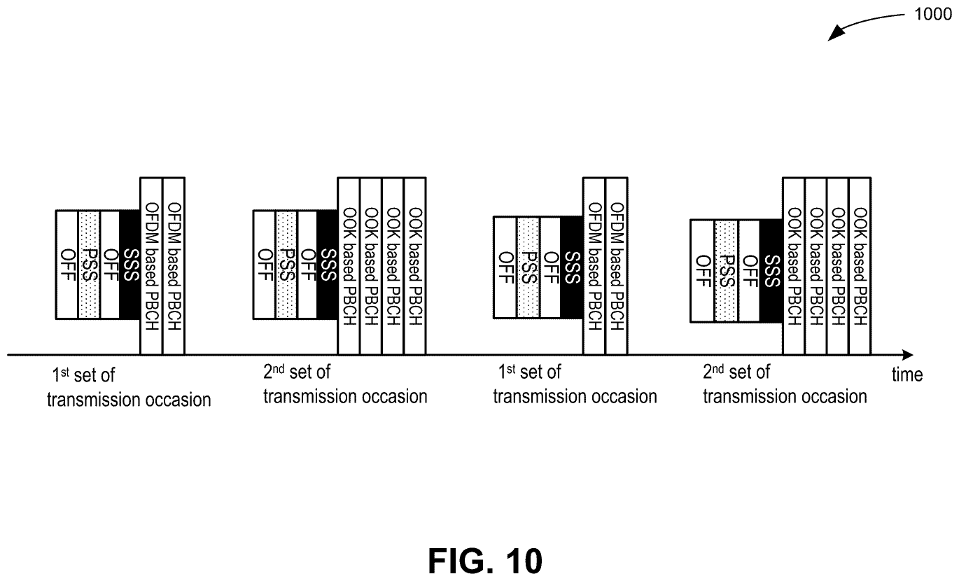

FIG. 10 illustrates a diagram 1000 that depicts first and second sets of transmission occasions, according to an example.

In an example, the WTRU may identify a set of transmission occasions based on one or more of an on/off pattern, a PSS and/or SSS sequence, and/or a time and/or frequency resource.

In an example, the WTRU may identify a set of transmission occasions based on an on/off pattern. For example, if synchronization signals in a transmission occasion are transmitted with a first on/off pattern, the WTRU may determine the transmission occasion to be a first set of transmission occasions. If synchronization signals in the transmission occasion are transmitted with a second on/off pattern, the WTRU may determine the transmission occasion to be a second set of transmission occasions.

In an example, the WTRU may identify a set of transmission occasions based on PSS and/or SSS sequence. For example, if synchronization signals in a transmission occasion are transmitted with a first sequence, the WTRU may determine the transmission occasion to be a first set of transmission occasions. If synchronization signals in the transmission occasion are transmitted with a second sequence, the WTRU may determine the transmission occasion to be a second set of transmission occasions.

In an example, the WTRU may identify a set of transmission occasions based on time and/or frequency resource. For example, if synchronization signals in a transmission occasion are transmitted in a time/frequency resource, the WTRU may determine the transmission occasion to be a first set of transmission occasions. If synchronization signals in the transmission occasion are transmitted in a second time and/or frequency resource, the WTRU may determine the transmission occasion to be a second set of transmission occasions. The time and/or frequency resource may be identified based on one or more of a carrier frequency, a subcarrier spacing, a bandwidth part, a frame index, a subframe index, a slot, a symbol, etc.

If a WTRU uses and/or activates a second receiver type (e.g., MR), the WTRU may scan and/or monitor synchronization rasters to detect, receive, and/or measure SSBs. The WTRU may scan the synchronization rasters until the WTRU receives a valid PSS and/or SSS of an SSB with OOK-based on/off patterns. After detecting the SSB, the WTRU may determine a cell ID (e.g., for MR/OFDM-based receiver), for example, jointly and based on the received PSS, SSS, and/or on/off pattern. In an example, the WTRU may determine 2 bits from the PSS, 7 bits from the SSS, and/or 2 bits from the on/off pattern. For example, the following equation may be used.

$${N}_{ID ( OFDM )}^{cell} = {N}_{PSS} {N}_{ID}^{( 1 )} + {N}_{SSS} {N}_{ID}^{( 2 )} + {N}_{ID}^{( 3 )}$$

where

$${N}_{ID}^{( 1 )}$$

may be indicated by receiving the PSS,

$${N}_{ID}^{( 2 )}$$

may be indicated by receiving the SSS, and

$${N}_{ID}^{( 3 )}$$

may be indicated by receiving the on/off pattern. N_{PSS} may represent a number of PSS IDs (e.g., three) and N_{SSS} may represent a number of SSS IDs.

In an example, the WTRU may receive a PBCH (e.g., an OFDM-based PBCH) in a first set of transmission occasions (e.g., even numbered transmission occasions) based on at least the timing of the received PSS and SSS (e.g., as indicated by timing information). The WTRU may decode the received PBCH and determine CORESET #0 and receive a SIB (e.g., SIB1) accordingly. The WTRU may receive RACH configurations (e.g., via a SIB) and initiate the initial access procedure (e.g., via Msg1, MsgA, and/or PRACH preamble transmission).

For example, the WTRU may transmit a PRACH (e.g., based on the received RACH configurations). Based on the transmitted PRACH, the WTRU may monitor a random access response (RAR) (e.g., from a gNB). The RAR may be based on RA-RNTI. For example, the following equation may be used.

RA-RNTI=1+s_id+14×t_id+14×80×f_id+14×80×8×ul_carrier_id

In this equation, s_id may range from zero to fourteen and may represent an index of a first OFDM symbol of a PRACH occasion.

In this equation, t_id may range from zero to eighty and may represent an index of a first slot of the PRACH occasion in a system frame.

In this equation, f_id may range from zero to eight and may represent an index of a PASCH occasion in the frequency domain

In this equation, ul_carrier_id may range may represent a UL carrier used for random access preamble transmission and may have a value of zero (e.g., indicating a normal uplink (NUL) carrier) or one (e.g., indicating a supplementary uplink carrier SUL).

The WTRU may receive a timing advance (TA) (e.g., indicated by timing information) and/or a Random Access Preamble Identifier (RAPID) associated with an RA-RNTI. If the WTRU does not receive the RAPID associated with the RA-RNTI, the WTRU may transmit PRACH again.

If the WTRU uses and/or activates a first receiver type (e.g., LR), the WTRU may scan and/or monitor synchronization raster to detect, receive, and/or measure SSBs. The WTRU may scan synchronization rasters until the WTRU receives one or more configured (e.g., valid) OOK-based on/off patterns. After detecting the SSB, the WTRU may determine a cell ID (e.g., for LR/OOK-based receiver) or a part of the cell ID (e.g., 2-bits from the detected on/off pattern).

In an example, the WTRU may receive a PBCH (e.g., an OOK-based PBCH) in a second set of transmission occasions (e.g., odd numbered transmission occasions). The reception may be based on the determined cell ID and/or the part of the cell ID (e.g., based on the detected on/off pattern).

In an example, the time and/or frequency resource for receiving the PBCH may be predetermined and/or configured (e.g., relative to the detected SSBs). The WTRU may receive the PBCH after a determined and/or configured time offset from the detected pattern.

In an example, the time and/or frequency resource for receiving the PBCH may be within predefined and/or configured time and/or frequency resources. Within the predefined and/or configured time and/or frequency resources, the WTRU may scan until receiving the PBCH.

The PBCH (e.g., a master information block (MIB)) may indicate one or more of: part of cell ID, a system frame number, SubCarrierSpacingCommon (e.g., 15 kHz, 60 kHz, 30 kHz or 120 kHz), ssb-SubcarrierOffset (e.g., 0 . . . 15), DMRS position (e.g., dmrs-TypeA-Position), one or more low power DL resources for receiving initial access related information (e.g., RAR), cell barred (e.g., barred or not barred), intra-frequency reselection (e.g., allowed or not allowed), number of SSB sets, RACH configuration for LP transmitter, etc.

In an example, the WTRU may determine a cell ID (e.g., for LR/OOK-based receiver) based on one or more of the part of the cell ID (e.g., from the detected on/off pattern), time and/or frequency offset of the detected PBCH, and/or indicated information via an LP MIB (PBCH). For example, the WTRU may determine a first part of the cell ID (e.g., two bits) from the detected on/off pattern. The WTRU may determine a second part of the cell ID based on the time offset (e.g., three bits) (e.g., symbol offset and/or the frequency offset—e.g., RB, RE, subband, Bandwidth Parts) from the detected SSB (e.g., PSS and/or SSS symbol). The WTRU may determine a third part of the cell ID based on the information via MIB (e.g., three bits). For example, one or more of the equations below for

$${N}_{ID ( LP )}^{cell}$$

may be used.

$${N}_{ID ( LP )}^{cell} = {N}_{Time / freuqency offset} {N}_{ID}^{( 1 )} + {N}_{ID}^{( 3 )} , where {N}_{ID}^{( 1 )}$$

may be indicated by a time and/or frequency offset between SS and PBCH and

$${N}_{ID}^{( 3 )}$$

may be indicated by receiving ON/OFF pattern. N_{Time/frequency offset} may represent a number of candidate time/frequency offsets.

$${N}_{ID ( LP )}^{cell} = {N}_{Time offset} {N}_{ID}^{( 1 )} + {N}_{Frequency offset} {N}_{ID}^{( 2 )} + {N}_{ID}^{( 3 )} , where {N}_{ID}^{( 1 )}$$

may be indicated by receiving a time offset,

$${N}_{ID}^{( 2 )}$$

may be indicated by receiving a frequency offset, and

$${N}_{ID}^{( 3 )}$$

may be indicated by receiving an on/off pattern. N_{Time offset} may represents a number of candidate time offsets and N_{Frequency offset} may represents a number of candidate frequency offsets.

$${N}_{ID ( LP )}^{cell} = {N}_{MIB} {N}_{ID}^{( 1 )} + {N}_{Time / frequency offset} {N}_{ID}^{( 2 )} + {N}_{ID}^{( 3 )} , wherein , {N}_{ID}^{( 1 )}$$

may be indicated by an MIB,

$${N}_{ID}^{( 2 )}$$

may be indicated by a time and/or frequency offset between SS and PBCH, and

$${N}_{ID}^{( 3 )}$$

may be indicated by receiving an ON/OFF pattern. N_{MIB} may represent a number of candidates of the part of cell IDs via MIB and N_{Time/frequency offset} may represents a number of candidate time and/or frequency offsets.

$${N}_{ID ( LP )}^{cell} = {N}_{MIB} {N}_{ID}^{( 1 )} + {N}_{Time offset} {N}_{ID}^{( 1 )} + {N}_{Frequency offset} {N}_{ID}^{( 2 )} + {N}_{ID}^{( 3 )} , where {N}_{ID}^{( 1 )}$$

may be indicated by MIB,

$${N}_{ID}^{( 2 )}$$

may be indicated by a time and/or frequency offset between SS and PBCH,

$${N}_{ID}^{( 2 )}$$

may be indicated by receiving a time offset,

$${N}_{ID}^{( 3 )}$$

may be indicated by receiving a frequency offset, and

$${N}_{ID}^{( 4 )}$$

may be indicated by receiving an ON/OFF pattern. N_{MIB} may represent a number of candidates of the part of cell IDs via MIB, N_{Time offset} may represent a number of candidate time offsets, and N_{Frequency offset} may represent a number of candidate frequency offsets.

In an example, a WTRU may receive configuration information (e.g., low-power RACH configuration information) (e.g., based on a received PBCH and/or low power SI—e.g., via OOK transmission), including one or more UL resources for transmitting a low-power (e.g., PRACH) preamble.

In an example, the WTRU may determine, receive, and/or be configured with a PRACH preamble (e.g., WTRU-specific PRACH preamble) to be transmitted (e.g., in collision-free random access (CFRA)). In an example, the WTRU may determine an OOK-based PRACH preamble based on the WTRU's ID and/or the cell ID.

The WTRU may transmit the low-power preamble in the configured UL resources. The WTRU may indicate the WTRU's type, for example, via preamble transmission (e.g., based on OOK/BPSK). Some examples of OOK sequences that may be transmitted by the WTRU are provided below.

In an example, the combination of modulation and length may be (1, 4) (e.g., modulation=1 and length=4). In this example, four OOK sequences that the WTRU may transmit include [0 1 0 1], [0 1 1 0], [1 0 0 1], and [1 0 1 0].

In an example, the combination of modulation and length may be (1, 6) (e.g., modulation=1 and length=6). In this example, four OOK sequences that the WTRU may transmit include [1 0 1 0 1 0], [0 1 0 1 0 1], [1 0 0 1 0 1], and [1 0 1 0 0 1].

In an example, the combination of modulation and length may be (1, 8) (e.g., modulation=1 and length=8). In this example, four OOK sequences that the WTRU may transmit include [1 0 1 0 0 1 0 1], [1 0 1 0 1 0 0 1], [1 0 0 1 0 1 0 1], and [0 1 0 1 0 1 0 1].

In an example, the combination of modulation and length may be (2, 8) (e.g., modulation=2 and length=8). In this example, four OOK sequences that the WTRU may transmit include [0 1 0 1 1 0 0 1], [0 1 1 0 0 1 0 1], [0 1 1 0 1 0 0 1], and [1 0 0 1 0 1 1 0].

In an example, the combination of modulation and length may be (2, 12) (e.g., modulation=2 and length=12). In this example, four OOK sequences that the WTRU may transmit include [1 0 0 1 1 0 0 1 1 0 0 1], [0 1 1 0 1 0 0 1 1 0 0 1], [0 1 1 0 0 1 1 0 1 001], and [0 1 1 0 0 1 0 1 1 0 0 1].

In an example, the combination of modulation and length may be (2, 16) (e.g., modulation=2 and length=16). In this example, four OOK sequences that the WTRU may transmit include [1 0 0 1 0 1 0 1 1 0 0 1 1 0 0 1], [1 0 0 1 1 0 0 1 0 1 1 0 0 1 0 1], [1 0 0 1 1 0 1 0 0 1 0 1 1 0 0 1], and [1 0 1 0 0 1 1 0 0 1 1 0 0 1 0 1].

In an example, the combination of modulation and length may be (4, 16) (e.g., modulation=4 and length=16). In this example, a first set of four OOK sequences that the WTRU may transmit include [0 1 1 0 1 0 0 1 1 0 1 0 1 0 1 0], [0 1 1 0 1 0 1 0 1 0 0 1 1 0 1 0], [1 0 1 0 0 1 1 0 1 0 1 0 1 0 0 1], [1 0 1 0 1 0 0 1 1 0 1 0 0 1 1 0]. In this example, a second set of four OOK sequences that the WTRU may transmit may include [1 0 0 0 1 0 0 0 0 0 0 1 0 0 1 0], [1 0 0 0 0 1 0 0 1 0 0 0 0 0 1 0], [1 0 0 0 0 1 0 0 0 1 0 0 1 0 0 0], and [1 0 0 0 0 1 0 0 0 0 0 1 0 0 0 1].

In an example, the combination of modulation and length may be (4, 32) (e.g., modulation=4 and length=32). In this example, a first set of four OOK sequences that the WTRU may transmit include [0 1 0 1 1 0 1 0 1 0 1 0 1 0 0 1 1 0 1 0 0 1 1 0 0 1 1 0 0 1 0 1], [0 1 1 0 0 1 0 1 0 1 1 0 0 1 0 1 1 0 0 1 1 0 1 0 1 0 1 0 0 1 0 1], [0 1 0 1 0 1 0 1 1 0 1 0 1 0 0 1 1 0 1 0 1 0 0 1 1 0 1 0 0 1 1 0], and [0 1 0 1 0 1 1 0 0 1 0 1 1 0 1 0 0 1 1 0 0 1 1 0 1 0 1 0 0 1 0 1]. In this example, a second set of four OOK sequences that the WTRU may transmit may include [0 0 0 1 1 0 0 0 0 0 0 1 0 0 0 1 1 0 0 0 0 0 0 1 0 0 0 1 0 1 0 0], [0 0 0 1 0 1 0 0 1 0 0 0 1 0 0 0 0 1 0 0 0 1 0 0 0 0 0 1 0 1 0 0], [0 0 1 0 0 0 1 0 1 0 0 0 0 1 0 0 1 0 0 0 0 0 0 1 0 0 1 0 0 0 1 0], and [0 0 1 0 0 1 0 0 0 0 0 1 1 0 0 0 0 0 1 0 1 0 0 0 0 1 0 0 0 0 1 0].

In an example, a WTRU may indicate a device type (e.g., of the WTRU). For example, the WTRU may indicate a device type based on information bits (e.g., where a value of 0 0 may indicate back scattering, a value of 01 may indicate sequence-based transmission, and a value of 10 may indicate main-radio-based transmission) by using OOK and/or BPSK. For example, the WTRU may use preamble partitioning for indicating the device type (e.g., a first partition may indicate back scattering, a second partition may indicate sequence-based transmission, and a third partition may indicate main-radio-based transmission). For example, the device type may include an indication of whether the WTRU supports backscattering, supports sequence-based indications, supports main radio, etc.

After PRACH preamble transmission, the WTRU may monitor to receive a RAR (e.g., within one or more low power DL resources for receiving initial access related information). In an example, the WTRU may receive a RAR based on OOK/BPSK indicating the transmitted preamble was received and indicating a time associated with the preamble transmission. If data transmission and/or reception is to be performed, the WTRU may activate the MR, for example, for data transmission and/or reception, in addition to transmitting one or more requests, setting up the connection, and so forth.

The WTRU may receive the RAR based on LP RA-RNTI. For example, an OOK-based RAR transmission may be transmitted with cyclic redundancy check (CRC) based on the LP RA-RNTI. For example, the OOK-based RAR transmission may indicate an RAPID associated with the LP RA-RNTI. For example, the variable LP RA-RNTI may be constrained based on available resources for OOK-based transmission. For example, one of more of the following equations may be used.

LP RA-RNTI#1=1+s_id+N(s_id)×t_id+N(t_id)×20×f_id

LP RA-RNTI#1=1+s_id+N(s_id)×t_id

where s_id may represent a constrained range considering the size of an OOK/BPSK-based UL transmission (e.g., 0=<s_id<7), t_id may represent an index of the first slot of an LP PRACH occasion in OOK/BPSK applicable system frames (e.g., 0=<t_id<20), and f_id may represent an index of the LP PRACH occasion (e.g., which may not be supported for OOK-based receivers/initial access).

In an example, the WTRU may transmit a low-power RACH (e.g., potentially with increased power/backscattering gain). If the WTRU does not receive the RAR (e.g., in the resources associated with the low-power RACH), the WTRU may transmit the low-power RACH with increased power/backscattering gain. If the WTRU does not receive the RAR within a time duration (e.g., as measured by a counter), the WTRU may fall back to MR-based initial access.

In an example, a WTRU may measure one or more PSSs and/or SSSs with an ON/OFF pattern.

Based on the measurement (e.g., one or more of RSRP, Reference Signal Received Quality (RSRQ), Received Signal Strength Indicator (RSSI), Signal-to-Interference-plus-Noise Ratio (SINR), LP-RSRP, LP-RSRQ, LP-RSSI, LP-SINR and/or hypothetical PDCCH Block Error Rate (BLER)), the WTRU may determine a cell to reselect.

Based on the determination of the cell to reselect, the WTRU may start a cell reselection procedure. For example, the WTRU may decode a PBCH and receive one or more SIBs (e.g., based on a determined cell ID).

In an example, the cell reselection procedure may be based on a currently activated receiver. In another example, the cell reselection procedure may be based on a default receiver (e.g., LR).

In an example, the cell reselection procedure may be based on a currently activated transmitter. In another example, the cell reselection procedure may be based on a default transmitter (e.g., LP transmitter).

Based on the decoded PBCH and/or the one or more SIBs, the WTRU may transmit a PRACH (e.g., Msg1). The transmission may be based on the determined transmitter. For example, if an LP transmitter is determined, the WTRU may transmit an LP PRACH.

The WTRU may monitor a RAR (e.g., from a gNB) based on the transmitted PRACH and/or the determined receiver (e.g., LR).

If the WTRU received a RAR (e.g., scrambled with corresponding RA-RNTI and/or with RAPID), the WTRU may transmit a PUSCH (e.g., for Msg 3). If the WTRU does not receive the RAR (e.g., in the resources associated with the low-power RACH), the WTRU may transmit the low-power RACH with increased power/backscattering gain. If the WTRU does not receive the RAR within time duration (e.g., as measured by a counter), the WTRU may fall back to MR-based initial access.

In an example, a WTRU may request an on-demand PBCH. In this example, a WTRU may turn on (e.g., turn itself on) and determine a receiver type to be used for initial access.

For example, the WTRU may support initial access with LR first and then initial access with MR if LR-based initial access fails. There may be some exception cases (e.g., transmission/reception with low latency data).

If the WTRU activated an MR, the WTRU may scan an SSB over synchronization rasters until the WTRU receives a valid PSS and/or SSS of an SSB with OOK-based ON/OFF patterns.

The WTRU may determine a cell ID based on the received PSS and/or SSS.

If the WTRU activated an LR, the WTRU may scan an SSB over Synchronization rasters until the WTRU receives a valid ON/OFF pattern.

The WTRU may determine a UL resource to request a PBCH based on the received ON/OFF pattern.

The WTRU may transmit a UL signal indicating OOK modulation in the determined UL resource to request the PBCH.

The WTRU may receive the PBCH based on the received ON/OFF pattern and/or a time offset between the received SSB and the PBCH and the requested OOK modulation.

If data transmission and/or reception is to be done, the WTRU may activate the MR (e.g., for data transmission/reception) and request a remaining procedure for initial access.

The systems and methods of this example may provide a number of advantages and/or benefits. For example, systems and methods described in this example may reduce overhead for supporting OOK-based PBCH and may obviate SIB1 detection for LR before MR activation.

In an example, a WTRU may indicate WTRU capability with regard to support of multiple UL transmitters. For example, the WTRU may indicate WTRU capabilities regarding one or more supported transmitter types and/or one or more supported receiver types (e.g., via one or more of RRC, MAC CE, uplink control information (UCI), and/or user equipment assistance information (UAI)).

The WTRU may indicate one or more supported transmitter types. For example, the WTRU may indicate one or more of a low complexity UL transmitter (e.g., a UL transmitter based on backscattering with/without energy storage and/or signal amplification), a high complexity UL transmitter (e.g., a UL transmitter with energy storage and signal amplification), and/or an MR-based UL transmitter. Among candidate UL transmitters, some UL transmitters (e.g., a high complexity UL transmitter and/or an MR-based UL transmitter) may be supported (e.g., as mandatory). In the case of mandatory UL transmitters, the WTRU may not indicate associated capabilities.

The WTRU may indicate one or more supported receiver types. For example, the WTRU may indicate one or more of a low complexity DL receiver (e.g., DL receiver based on OOK), a high complexity DL receiver (e.g., a DL receiver based on OFDM) and/or an MR-based DL receiver. Among candidate DL receivers, some DL receivers (e.g., a low complexity DL receiver and/or an MR-based DL receiver) may be supported (e.g., as mandatory). In the case of mandatory DL receivers, the WTRU may not indicate associated capabilities.

In an example, a WTRU may determine a receiver and/or transmitter type to be used for initial access. The determination may be based on one or more of WTRU capability (e.g., indicated capability to a gNB), need of transmission/reception, data/service type (e.g., latency), and/or initial access failure counter/timer

In an example, the WTRU may determine a receiver and/or transmitter type based on WTRU capability. For example, if the WTRU supports one or more of low-power receivers (e.g., a low complexity DL receiver and/or a high complexity DL receiver) and/or low-power transmitters (e.g., a low complexity UL transmitter and/or high complexity UL transmitters), then the WTRU may determine to use low-power receivers and/or low-power transmitters. Otherwise, the WTRU may determine to use an MR.

In an example, the WTRU may determine a receiver and/or transmitter type based on a type of transmission and/or reception. For example, if the WTRU is going to transmit and/or receive one or more packets (e.g., within a time window—e.g., from the start of the initial access), the WTRU may determine to use an MR for transmission and/or reception. If the WTRU does not have one or more packets (e.g., within a time window—e.g., from the start of the initial access), the WTRU may determine to use low power receivers and/or transmitters for initial access.

In an example, the WTRU may determine a receiver and/or transmitter type based on a type of data to be transmitted and/or received. For example, if the WTRU is going to transmit and/or receive one or more packets with low latency (e.g., URLLC), the WTRU may determine to use MR for transmission/reception. If the WTRU is going to transmit and/or receive the one or more packets with regular latency (e.g., eMBB), the WTRU may determine to use low-power receivers and/or transmitters for initial access.

In an example, if the WTRU firstly determines a low-power receiver and/or transmitter for the initial access and the initial access based on the determined receiver and/or transmitter fails (e.g., if a number of failures with low-power receiver and/or transmitter exceeds an initial access failure counter threshold and/or initial access fails even after expiration of the initial access failure timer), the WTRU may determine to use the MR for the initial access.

In an example, if the WTRU determined MR-based initial access, the WTRU may scan SSBs over Synchronization rasters (e.g., until the WTRU receives valid PSS and SSS with OOK-based ON/OFF patterns). Based on the received SSBs and ON/OFF patterns, the WTRU may determine a cell ID. For example, the WTRU may identify a cell ID based on received synchronization signals and ON/OFF pattern. For example, the following equation may be used.

$${N}_{ID}^{cell} = {N}_{PSS} {N}_{ID}^{( 1 )} + {N}_{ID}^{( 2 )} + {N}_{ID}^{( 3 )}$$

may be indicated by receiving a PSS and

$${N}_{ID}^{( 2 )}$$

may be indicated by receiving a SSS. N_{PSS} may represent a number of PSS IDs (e.g., three).

Based on an identified cell ID, the WTRU may measure a PBCH demodulation reference signal (DMRS). Based on the measurement, the WTRU may estimate a channel for decoding PBCH.

The WTRU may receive a PBCH (e.g., an OFDM-based PBCH) (e.g., based on the estimated channel). The PBCH may indicate one or more of the following: system frame number, SubCarrierSpacingCommon (e.g., 15 kHz, 60 kHz, 30 kHz or 120 kHz), ssb-SubcarrierOffset (e.g., 0 . . . 15), DMRS position (e.g., dmrs-TypeA-Position), PDCCH config, cell barred (e.g., barred or not barred), intra frequency reselection (e.g., allowed or not allowed), number of SSB sets, etc.

Based on the received information (e.g., in the PBCH), the WTRU may receive random access parameters (e.g., via SIB1). Based on the received random access parameters, the WTRU may transmit a message (e.g., Msg1) (e.g., via PRACH).

In an example, if the WTRU determined to use LR-based initial access, the WTRU may scan SSBs over synchronization rasters (e.g., until the WTRU receives valid OOK-based ON/OFF patterns).

In an example, the WTRU may receive an indication of UL resources (e.g., via OOK-based ON/OFF patterns).

In an example, the WTRU may request transmission of a PBCH (e.g., via transmission of one or more UL signals in the indicated UL resources). The WTRU may indicate one or more of the following in the request: modulation type (e.g., BPSK and/or OOK), modulation (e.g., for OOK-based PBCH; for example, the WTRU may indicate one or more of M=1, 2, 4, 8 and/or 16), application of reliability enhancement schemes (e.g., the WTRU may indicate whether to apply repetitions, a number of repetitions, a coding scheme, and/or a coding rate), and/or one or more DL resources for receiving the PBCH (e.g., the WTRU may indicate time and/or frequency resources for receiving the PBCH). The WTRU may indicate an index associated with DL resources (e.g., among one or more predefined and/or configured indexes, wherein each index may be associated with DL resources).

Based on the WTRU request, the WTRU may receive a PBCH (e.g., an OOK-based PBCH). For example, the WTRU may measure a PBCH preamble (e.g., to set a threshold for deciding ON or OFF). The WTRU may receive the PBCH (e.g., based on a measurement of the preamble). The PBCH may indicate one or more of the following: cell ID, system frame number, SubCarrierSpacingCommon (e.g., 15 kHz, 60 kHz, 30 kHz or 120 kHz), ssb-SubcarrierOffset (e.g., 0 . . . 15), DMRS position (e.g., dmrs-TypeA-Position), PDCCH configuration, cell barred (e.g., barred or not barred), intra frequency reselection (e.g., allowed or not allowed), number of SSB sets, MR UL resource to trigger remaining initial access procedure after activating MR (e.g., RACH configuration), etc.

In an example, the WTRU may receive an LP-SIB (e.g., an OOK/BPSK-based SIB). For example, the WTRU may receive a RACH configuration.

In an example, a WTRU may trigger a remaining initial access procedure after activating an MR. For example, the WTRU may transmit one or more UL signals (e.g., in an MR UL resource to trigger the remaining initial access procedure). For example, the WTRU may receive remaining SIBs associated with processing the remaining initial access procedure (e.g., after LR-based initial access). The WTRU may trigger the remaining initial access procedure based on receiving a wake up signal and/or a type of transmission and/or reception.

In an example, the WTRU may trigger the remaining initial access procedure when the WTRU receives a wake up signal (e.g., if the WTRU only processed an LR-based initial access procedure) (e.g., from a gNB). Otherwise (e.g., if the WTRU processed an MR-based initial access procedure potentially with an LR-based initial access procedure), then the WTRU may monitor a PDCCH (e.g., without triggering the remaining initial access procedure).

In an example, the WTRU may trigger the remaining initial access procedure based on the type of transmission and/or reception. For example, if the WTRU has to transmit and/or receive one or more packets, the WTRU may trigger the remaining initial access procedure. If the WTRU does not have one or more packets, the WTRU may not trigger the remaining initial access procedure.

In an example, a synchronization signal may be determined (e.g., by a WTRU) based on a type of the WTRU.

The WTRU may turn on a device (e.g., the WTRU may turn itself on).

The WTRU may scan an SSB over synchronization rasters until the WTRU receives a valid PSS of an SSB.

The WTRU may determine an SSS time and/or frequency location based on the received PSS and the WTRU type.

The WTRU may receive an SSS based on the determined time/frequency location.

The WTRU may receive a device-specific PBCH based on the received SSS and/or the WTRU type.

In an example, the WTRU may be equipped and/or configured to support multiple radio and/or radio configurations (i.e., multiple WTRU types), each with an associated configuration. The configurations may include different configurations for synchronization signals (e.g., different formats, resources, content, etc.), and the WTRU may determine, based on a first received synchronization signal (e.g., PSS) and the WTRU's activated and/or available radio type(s), the resources and configuration to monitor for subsequent signals (e.g., a second synchronization signal and/or associated control signaling), if any.

Parts (or all) of the following example details can be used in combination with, and/or In replacement of, the examples described above. Common details with previous examples may be omitted and/or reused.

In one example, a WTRU may indicate to the network whether the WTRU supports different WTRU-types (e.g., using WTRU capabilities, RRC configuration etc.). The WTRU-type(s) supported may be configured WTRU-types with a set of configurations for a different radio equipment and/or radio configuration and/or configuration set. The WTRU may indicate the support for one or more of the WTRU types.

In an example, the WTRU may receive a configuration for supporting one or more WTRU types, where the different WTRU types may be associated with specific synchronization signals, control information, and/or initial access configurations (e.g., each WTRU type may be configured with a different SSB (or similar) format and/or configuration). In some examples, the WTRU may receive configuration information comprising a configuration (e.g., for each WTRU type).

The configuration information may comprise a first synchronization signal configuration (e.g., PSS).

The first synchronization signal configuration may indicate time and/or frequency resources. The WTRU may receive the configuration for a PSS over one or multiple frequency carriers, including the frequency resources within the carrier(s) where the PSS may be found (e.g., frequency block positions and/or widths). The WTRU may also be configured with timings (e.g., indicated by timing information) for where to monitor for a PSS (e.g., windows of time).

The first synchronization signal configuration may indicate a format. The format may be sequence-based. The WTRU (e.g., if the WTRU type supports receiving sequence signals) may receive a configuration to receive a sequence-based PSS, including a sequence configuration (e.g., sequence type—e.g., m-sequence, Gold sequence, Zadoff-Chu sequence, etc., possible sequence index/root number, etc.), and/or where the sequence maps to a first part of cell information (e.g., cell ID and/or supported WTRU-types).

The format may be OOK-based. The WTRU (e.g., if the WTRU type supports receiving sequence signals) may receive a configuration to receive an OOK-based PSS, where the signal may be time-coded with ON/OFF patterns, and where a configured set of patterns may correspond to a first part of cell information (e.g., cell ID and/or supported WTRU-types).

The configuration information may comprise a second synchronization signal configuration.

The second synchronization signal configuration may indicate time and/or frequency resources. The WTRU may receive a configuration for an SSS indicating the configured carrier(s), including the frequency resources within the carrier(s) where the SSS may be found (e.g., frequency block positions and/or widths). The WTRU may also be configured with timings (e.g., indicated by timing information) for where to monitor for an SSS. The time and/or frequency resources of an SSS may be mapped from the time and/or frequency position of the PSS (e.g., with a configured time and/or offset with respect to a PSS resource).

The second synchronization signal configuration may indicate a format. The format may be sequence-based. The WTRU (e.g., if the WTRU type supports receiving sequence signals) may receive the configuration to receive a sequence-based SSS, including a sequence configuration (e.g., sequence type—e.g., m-sequence, Gold sequence, Zadoff-Chu sequence, etc., possible sequence index/root number, etc.), and an indication of where the sequence maps to a second part of cell information.

The format may be OOK-based. The WTRU (e.g., if the WTRU type supports receiving sequence signals) may receive a configuration to receive an OOK-based SSS, where a signal may be time-coded with ON-OFF patterns, and where a configured set of patterns may correspond to a second part of cell information.

The configuration information may comprise control information signaling.

The control information may indicate time and/or frequency resources. The WTRU may receive the configuration for a control information channel on the configured carrier(s), including the frequency resources within the carrier(s) where the control information channel may be found (e.g., frequency block positions an/or widths). The WTRU may also be configured with timings (e.g., indicated by timing information) for where to monitor for a control information channel. The time and/or frequency resources of a control information channel may be mapped from the time and/or frequency position of the PSS and/or SSS (e.g., with a configured time and/or offset with respect to the PSS and/or SSS resources).

The control information may indicate a format.

The format may be OFDM-based. The WTRU (e.g., if the WTRU type supports receiving OFDM signals) may receive the configuration to receive OFDM control information, including a signal configuration (e.g., OFDM parameters), where the content may map to control and/or system information.

The format may be OOK-based. The WTRU (e.g., if the WTRU type supports receiving sequence signals) may receive ta configuration to receive OOK-based control information, where the signal may be time-coded with ON-OFF patterns, and where a configured set of patterns may correspond to control and/or system information.

The control information may comprise content. The WTRU may be configured to receive information for synchronization, initial access, further control channel, basic cell/network/system information (cell ID, network ID, monitoring resource configuration (CORESETs, etc.) etc.).

The content may be split into one or more control signals (e.g., MIB, SIBs—e.g., SIB1). The content and/or split may be different for different WTRU-types (e.g., the WTRU may be configured with a WTRU-type specific MIB and/or SIBs and/or equivalents).

In one example, the synchronization signals and control signaling for a given WTRU type may be configured within a “block” with adjacent time/frequency resources (e.g., SSB).

In one example, the synchronization signals and control signaling for another WTRU type may be configured with spacing (time/frequency gaps) between resources (e.g., to allow for the WTRU to receive and/or process the received signals—e.g., for lower capability WTRUs).

In one example, the WTRU may receive a (pre)configuration for two (or more) WTRU types, where each WTRU type may be configured with independent signaling (e.g., where the signals may be configured on different resources and/or not mapped/linked with each other).

For example, a first WTRU type may receive a configuration for PSS/SSS resources on a first carrier while a second WTRU type may receive a configuration for PSS/SSS resources on a second carrier.

In one example, the WTRU receives a configuration for two (or more) WTRU types, where some resources/signals may be common or may be commonly and/or simultaneously monitored.

The WTRU may receive the configuration for both an OOK-based WTRU-type and an OFDM/Sequence-based WTRU-type, where both PSSs may be configured over the same resources (e.g., the network may transmit a sequence-based PSS, repeated with ON/OFF patterns so that both types of WTRUs may receive the sequence-based PSS).

The WTRU may receive a configuration in which, for a first WTRU-type (e.g., the sequence/OFDM-based WTRU type), the PSS maps to a sequence-based SSS and/or OFDM-based control signaling, with a corresponding first set of resources (e.g., based on a first resource mapping).

The WTRU may receive a configuration in which, for a second WTRU-type (e.g., the OOK-based WTRU type), the PSS maps to an OOK-based SSS and OOK-based control signaling, with a corresponding second set of resources (e.g., based on a second resource mapping).

The WTRU may receive a configuration for a third WTRU-type (e.g., with the same receiver as the first or second WTRU-type), but with a third resource mapping to a differently configured SSS and/or control information (e.g., where the signals may use different repetition schemes, different transmission power, and/or different time/frequency resources to adapt to different WTRU-types with different processing and/or receiving capabilities).

The WTRU may receive a configuration for two or more WTRU-types (e.g., sharing a common PSS monitoring resource and format), but where the content included in the PSS may indicate whether the WTRU-type is supported by the cell. For instance, if the PSS indicates few bits of information, a subset of the bits may indicate which WTRU-types are supported (e.g., an OOK-based ON/OFF pattern where a first pattern indicates one of the bit to ‘0’ targets a first WTRU-type while the same bit of the pattern to ‘1’ indicates another WTRU-type). Alternatively, this could be indicated as a bitstring of bits where each bit represents support of a given WTRU-type.

In an example, a WTRU may determine a receiver/transmitter type to be used for initial access.

The WTRU may determine a receiver/transmitter type to be used for initial access based on WTRU capability (e.g., capability indicated to a gNB).

For example, the WTRU may determine a receiver/transmitter type based on WTRU capability. For example, if the WTRU supports one or more low-power receivers (e.g., a low complexity DL receiver or a high complexity DL receiver) and/or low-power transmitters (e.g., a low complexity UL transmitter or high complexity UL transmitters), then the WTRU may determine to use the low-power receivers and/or low-power transmitters. Otherwise, the WTRU may determine to use MR.

The WTRU may determine a receiver/transmitter type to be used for initial access based on need of transmission/reception

For example, the WTRU may determine a receiver/transmitter type based on the need of transmission/reception. For example, if the WTRU needs to transmit/receive one or more packets (e.g., within a time window from the start of the initial access), the WTRU may determine to use MR for transmission/reception. If the WTRU does not have one or more packets (e.g., within a time window from the start of the initial access), the WTRU may determine to use low-power receivers/transmitters for initial access.

The WTRU may determine a receiver/transmitter type to be used for initial access based on data/service type (e.g., latency).

For example, the WTRU may determine a receiver/transmitter type based on a type of data to be transmitted/received. For example, if the WTRU has to transmit/receive one or more packets with low latency (e.g., URLLC), the WTRU may determine to use MR for transmission/reception. If the WTRU has to transmit/receive the one or more packets with regular latency (e.g., eMBB), the WTRU may determine to use low-power receivers/transmitters for initial access.

The WTRU may determine a receiver/transmitter type to be used for initial access based on an initial access failure counter and/or timer

For example, if the WTRU first determines a low-power receiver/transmitter for the initial access and the initial access based on the determined receiver/transmitter fails (e.g., number of failures with a low-power receiver/transmitter exceeds an initial access failure counter threshold and/or initial access fails even after expiration of an initial access failure timer), the WTRU may determine to use MR for the initial access.

In an example, the WTRU may scan an SSB over synchronization rasters until the WTRU receives a valid PSS of an SSB. Based on one or more of the received PSS, the determined receiver/transmitter (e.g., for initial access), and/or the service type, the WTRU may receive an associated SSS. For example, the WTRU may receive a first SSS with a first time/frequency offset associated with a first transmitter/receiver/service type (e.g., from the received PSS). The WTRU may receive a second SSS with a second time/frequency offset associated with a second transmitter/receiver/service type (e.g., from the received SSS).

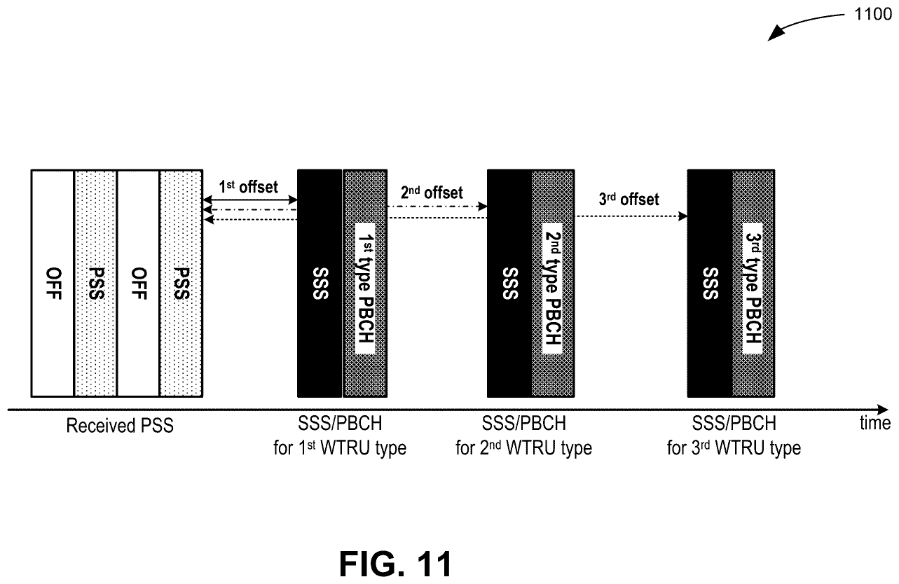

FIG. 11 illustrates a diagram 1100 that depicts example locations of SSSs and PBCHs based on a received PSS and/or a WTRU type and/or service type.

The WTRU may activate one or more radios/WTRU-types (e.g., upon waking-up the WTRU radio), turn on the WTRU, and/or turn on the WTRU for regular monitoring/synchronization, etc., based on the WTRU's capabilities and conditions (e.g., based on a traffic requirement, a battery-level/energy consideration, etc.). Based on the types of WTRUs/radios that the WTRU activated, the WTRU may monitor for a PSS on the resources corresponding to a received configuration and may receive one or more PSS.

The WTRU may monitor the configured PSS resources for the activated WTRU-types and determine which WTRU-type(s) is supported by the network/cell based on the reception of PSS in the configured resource.

In an example, the WTRU may determine the network/cell support of a WTRU-type (e.g., a sequence-based WTRU-type) based on receiving/detecting the presence of a sequence-based PSS in a PSS resource. For instance, the sequence signal strength may be higher than a configured threshold.

In an example, the WTRU may determine the network/cell support of a WTRU-type (e.g., a sequence-based WTRU-type) based on detecting a sequence-based PSS in a PSS resource whose sequence indicates, based on the WTRU-type configuration, that the WTRU-type is supported. For example, different WTRU-types may be associated with different sequence indexes.

In an example, the WTRU may determine the network/cell support of a WTRU-type (e.g., a OOK-based WTRU-type) based on detecting a ON/OFF pattern using a LR, and may further determine, based on the ON/OFF pattern, that the WTRU-type is supported. If multiple OOK-based WTRU-types are configured, the WTRU may further determine which of the WTRU-types are supported based on the ON/OFF pattern, the corresponding codepoint/value, and/or the received WTRU-type configuration indicating the associated codepoints.

In an example, the WTRU may monitor the resources corresponding to multiple activated WTRU-types and may receive a PSS for at least one of them, and may further selects one of the WTRU-types.

In an example, the WTRU may monitor for both LR-based and MR-based WTRU types, and may receive, in the PSS resources, the signal for both LR-based and MR-based PSS (e.g., a sequence that may be repeated with ON/OFF patterns). The WTRU may determine that both WTRU types are valid and may select one of the WTRU-types for subsequent operations (e.g., based on reception/transmission requirements, battery considerations, etc.).

In an example, the WTRU may monitor for both LR-based and MR-based WTRU types, and may receive, in the PSS resources, a valid signal for LR-based WTRU-type, but not for an MR-based PSS (e.g., a ON/OFF patterns but without the configured sequence). The WTRU may then select the LR-based WTRU-type and may turn off the MR-based radio/WTRU-type.

In an example, the WTRU may monitor for both LR-based and MR-based WTRU types, and may receive, in the PSS resources, a valid signal for an MR-based WTRU-type, but not for an LR-based PSS (e.g., a valid sequence for the MR-based WTRU-type, but without the ON/OFF pattern; or an ON/OFF pattern indicating that the LR-based WTRU-type is not supported). The WTRU then selects the MR-based WTRU-type and may turn off the LR-based radio/WTRU-type.

In an example, the WTRU may monitors for multiple LR-based WTRU types, and may receive, in the PSS resources, a ON/OFF pattern indicating that one of the activated LR-based WTRU types is supported (e.g., based on the pattern corresponding codepoint/value and received WTRU-type configuration). The WTRU may then select the LR-based WTRU-type and may turn off/deactivate the other LR-based radio/WTRU-types.

In an example, the WTRU may monitor the resources corresponding to multiple activated WTRU-types and may not receive a PSS for any of them, and may determine to fall back to another WTRU type for reception.

A WTRU monitoring LR-based WTRU types and not receiving the corresponding OOK pattern may determine to activate or reactivate MR-based radio/WTRU types and monitor for the next occasion of the configured resources for MR-based WTRU types.

A WTRU monitoring MR-based WTRU types and not receiving the corresponding PSS sequence may determine to activate or reactivate LR-based radio/WTRU types and monitor for the next occasion of the configured resources for LR-based WTRU types (e.g., if the WTRU detected ON/OFF patterns while monitoring for sequence-based PSS).

A WTRU monitoring LR-based WTRU types and not receiving the corresponding OOK pattern may determine to activate or reactivate other LR-based WTRU types (e.g., if the WTRU detected some OOK patterns, but the detected OOK patterns do not correspond to the activated LR-based WTRU types).

The WTRU may consider a failure of PSS reception after monitoring for a configured number of PSS resource occasions, or an expired timer after starting the monitoring of the resources, as an indication to fall back to another WTRU type for reception.

After selecting/confirming a WTRU-type based on the reception of a valid PSS, the WTRU may determine SSS/PBCH resources based on a received PSS and based on a selected WTRU-type.

The WTRU may determine the SSS/PBCH resources based on a received first mapping configuration of resources between the PSS and SSS/PBCH if the selected WTRU-type is the first WTRU type. For example, the SSS/PBCH may be part of an MR-based SSB (e.g. 5G NR SSB, 6G SSB, etc.) where (e.g., for 5G NR) the SSS resources are on the same frequency resources as the PSS, and with a two-symbol time offset. The WTRU may further determine the resources and position of the PBCH, including the position of the RS for PBCH demodulation (PBCH-DMRS).

The WTRU may determine the SSS/PBCH resources based on the received second mapping configuration of resources between the PSS and the SSS/PBCH if the selected WTRU-type is the second WTRU type. For example, the WTRU may determine the time and frequency resources as well as possible ON/OFF patterns for LR-based SSS based on the received configuration and mapping for the second WTRU-type.

The WTRU may monitor on the determined SSS resources (time/frequency positions) using the WTRU's determined and/or selected WTRU-type and perform synchronization procedure(s) associated with the synchronization signals. For instance, the WTRU may synchronize and/or calibrate the WTRU's radio, the WTRU may decode cell ID from the PSS/SSS, etc.

The WTRU may monitor for subsequent control channels such as a PBCH or a PDCCH on the determined resources associated with the received PSS/SSS and the WTRU type.

The WTRU may decode cell and/or system information such as MIB and SIB information and may prepare to monitor for subsequent SIBs, control channels, and/or paging occasions.

The WTRU may also receive the configuration and prepare to perform UL transmissions on resources (e.g. PRACH, PUCCH, etc.) based on the determined WTRU-type and/or following the received PSS/SSS and control channels.

The WTRU may receive WTRU-type specific cell/system information, such as a WTRU-type specific MIB/SIB. Each WTRU-type MIB/SIB may include different information based on the corresponding WTRU-type capabilities and/or requirements.

In a similar manner, the WTRU may be configured to determine subsequent synchronization signals and/or control channels based on more than the first synchronization channel (e.g., based on both PSS and SSS, or based on a PSS, SSS, and some control signaling), jointly indicating-directly or indirectly—the WTRU-types supported by the network and/or cell.

Common SSBs for both LR (e.g., OOK-based) and MR (e.g., OFDM-based) may be supported, where a WTRU may receive an OOK-based PBCH and an OFDM-based PBCH in a first set of SSBs and a second set of SSBs, respectively. If the WTRU receives the OOK-based PBCH (e.g., via an LR), the WTRU may support a simplified initial access procedure and a remaining initial access procedure after activating an MR. For instance, an example set of actions (e.g., steps) that the WTRU may perform are described below.

In an action (e.g., a first action), a WTRU may be turned on (e.g., may turn itself on) and the WTRU may determine a receiver type to be used for initial access.

For example, the WTRU may support performing (or attempting to perform) initial access with an LR (e.g., included in the WTRU) first and then perform initial access with an MR (e.g., included in the WTRU) if the LR-based attempt at initial access fails. In this example, some exception cases (e.g., specified by a configuration of the WTRU) may apply (e.g., transmission and/or reception with low latency data may be a possible exception).

In an action (e.g., a second action), if the WTRU has activated the MR, the WTRU may scan one or more SSBs over synchronization rasters until the WTRU receives a valid PSS and/or SSS of an SSB with one or more OOK-based ON/OFF patterns.

The WTRU may determine a cell identity (ID) based on the received PSS, SSS and/or ON/OFF pattern(s). For example, the WTRU may determine two bits from the PSS, seven bits from the SSS, and/or two bits from ON/OFF pattern(s).

The WTRU may receive an OFDM-based PBCH in a first set of transmission occasions (e.g., even numbered transmission occasions) based on at least the timing of the received PSS and/or SSS (e.g., timing advances indicated by timing information).

The WTRU may receive an SIB (e.g., SIB1) based on the received PBCH.

The WTRU may transmit a message (e.g., Msg1) based on the received SIB.

In an action (e.g., a third action), if the WTRU activated the LR, the WTRU may scan one or more SSBs over synchronization rasters until the WTRU receives a valid ON/OFF pattern.

The WTRU may determine a part of a cell ID (e.g., two bits) based on the received ON/OFF pattern.

The WTRU may receive an OOK-based PBCH in a second set of transmission occasions (e.g., odd numbered transmission occasions) based on the part of cell ID and/or the received ON/OFF pattern (e.g., time offset from the ON/OFF pattern).

The WTRU may determine one or more uplink (UL) resources for transmitting a low-power preamble based on the received PBCH.

The WTRU may transmit the low-power preamble indicating a device type (e.g., whether the WTRU supports backscattering, sequence-based, and/or main radio) in the determined one or more UL resources.

The WTRU may receive a random access response (RAR) based on OOK indicating that the low-power preamble was received and/or indicating a time associated with the preamble transmission.

The WTRU may activate the MR (e.g., for data transmission/reception) (e.g., based on determining that a condition for determining whether to activate the MR is satisfied). The WTRU may request and/or perform a remaining procedure for initial access (e.g., connection set up) using the MR.

Systems and methods described above may provide a number of advantages and/or benefits. For example, systems and methods described above may reduce overhead for supporting separate synchronization signals for MR and LR. Furthermore, systems and methods described herein may facilitate additional WTRU power saving from initial access by using LR.

In an example, a WTRU may request an on-demand PBCH. In this example, a WTRU may turn on (e.g., turn itself on) and determine a receiver type to be used for initial access.

For example, the WTRU may support initial access with LR first and then initial access with MR if LR-based initial access fails. There may be some exception cases (e.g., transmission/reception with low latency data).

If the WTRU activated an MR, the WTRU may scan an SSB over synchronization rasters until the WTRU receives a valid PSS and/or SSS of an SSB with OOK-based ON/OFF patterns.

The WTRU may determine a cell ID based on the received PSS and/or SSS.

If the WTRU activated an LR, the WTRU may scan an SSB over Synchronization rasters until the WTRU receives a valid ON/OFF pattern.

The WTRU may determine a UL resource to request a PBCH based on the received ON/OFF pattern.

The WTRU may transmit a UL signal indicating OOK modulation in the determined UL resource to request the PBCH.

The WTRU may receive the PBCH based on the received ON/OFF pattern and/or a time offset between the received SSB and the PBCH and the requested OOK modulation.

If data transmission and/or reception is to be done, the WTRU may activate the MR (e.g., for data transmission/reception) and request a remaining procedure for initial access.

The systems and methods of this example may provide a number of advantages and/or benefits. For example, systems and methods described in this example may reduce overhead for supporting OOK-based PBCH and may obviate SIB1 detection for LR before MR activation.

In an example, a synchronization signal may be determined (e.g., by a WTRU) based on a type of the WTRU.

The WTRU may turn on a device (e.g., the WTRU may turn itself on).

The WTRU may scan an SSB over synchronization rasters until the WTRU receives a valid PSS of an SSB.

The WTRU may determine an SSS time and/or frequency location based on the received PSS and the WTRU type.

The WTRU may receive an SSS based on the determined time/frequency location.

The WTRU may receive a device-specific PBCH based on the received SSS and/or the WTRU type.

In an example, the WTRU may be equipped and/or configured to support multiple radio and/or radio configurations (i.e., multiple WTRU types), each with an associated configuration. The configurations may include different configurations for synchronization signals (e.g., different formats, resources, content, etc.), and the WTRU may determine, based on a first received synchronization signal (e.g., PSS) and the WTRU's activated and/or available radio type(s), the resources and configuration to monitor for subsequent signals (e.g., a second synchronization signal and/or associated control signaling), if any.

The systems and methods of this example may provide a number of advantages and/or benefits. For example, systems and methods described in this example may reduces synchronization overhead for supporting multiple WTRU types.

1. A wireless transmit/receive unit (WTRU) comprising:
a low-power radio;
a main radio; and
a processor configured to:
determine at least a portion of a cell identity (ID) based on an on/off pattern associated with a synchronization signal block (SSB);
receive, via the low-power radio, an on-off keying (OOK)-based physical broadcast channel (PBCH) based on the portion of the cell ID and the on/off pattern;
transmit, via the low-power radio, a low-power preamble in one or more uplink resources; and
receive, via the low-power radio, an OOK-based random access response (RAR) indicating that the low-power preamble was received.

2. The WTRU of claim 1, wherein the transmission of the low-power preamble and the reception of the OOK-based RAR are a first portion of a random access channel (RACH) procedure; and
wherein the processor is further configured to:
determine to use the main radio for performing a second portion of the RACH procedure.

3. The WTRU of claim 2, wherein the processor is configured to:
receive configuration information that indicates a condition; and
determine to use the main radio for performing the second portion of the RACH procedure based on the condition.

4. The WTRU of claim 1, wherein the low-power preamble indicates a device type of the WTRU.

5. The WTRU of claim 1, wherein the portion of the cell ID based on the on/off pattern comprises two bits that are indicated by the on/off pattern.

6. The WTRU of claim 1, wherein the processor is further configured to:
receive configuration information that indicates the low-power radio is to be used for initial access.

7. The WTRU of claim 1, wherein the OOK-based RAR indicates a time associated with the transmission of the low-power preamble.

8. The WTRU of claim 1, wherein the processor is further configured to:
receive, via the main radio, a primary synchronization signal (PSS) and a secondary synchronization signal (SSS) in the SSB, wherein the SSB comprises an on-off keying (OOK)-based on/off pattern;
determine the cell ID based on the PSS, the SSS, and the OOK-based on/off pattern;
receive, via the main radio, an orthogonal frequency-division multiplexing (OFDM)-based physical broadcast channel (PBCH) based on timing information associated with the PSS and the SSS;
receive, via the main radio and based on the OFDM-based PBCH, a system information block (SIB); and
transmit a message via the main radio and based on the SIB.

9. The WTRU of claim 8, wherein the processor is further configured to:
receive the OFDM-based PBCH via a first set of transmission occasions; and
receive the OOK-based PBCH via a second set of transmission occasions.

10. The WTRU of claim 9, wherein the first set of transmission occasions is a set of even-numbered transmission occasions, and wherein the second set of transmission occasions is a set of odd-numbered transmission occasions.

11. The WTRU of claim 1, wherein the low-power radio is characterized by a capacity to use OOK and a lack of a capacity to use OFDM, and wherein the main radio is characterized by the capacity to use OFDM.

12. A method performed by a wireless transmit/receive unit (WTRU), the method comprising:
determining at least a portion of a cell identity (ID) based on an on/off pattern associated with a synchronization signal block (SSB);
receiving, via a low-power radio, an on-off keying (OOK)-based physical broadcast channel (PBCH) based on the portion of the cell ID and the on/off pattern;
transmitting, via the low-power radio, a low-power preamble in one or more uplink resources; and
receiving, via the low-power radio, an OOK-based random access response (RAR) that indicates that the low-power preamble was received.

13. The method of claim 12, wherein the transmission of the low-power preamble and the reception of the OOK-based RAR are a first portion of a random access channel (RACH) procedure; and
wherein the method further comprises:
determining to use a main radio for performing a second portion of the RACH procedure.

14. The method of claim 13, wherein the method further comprises:
receiving configuration information that indicates a condition; and
determining to use a main radio for performing the second portion of the RACH procedure based on the condition.

15. The method of claim 12, wherein the low-power preamble indicates a device type of the WTRU.

16. The method of claim 12, wherein the portion of the cell ID based on the on/off pattern comprises two bits that are indicated by the on/off pattern.

17. The method of claim 12, further comprising:
receiving configuration information that indicates the low-power radio is to be used for initial access.

18. The method of claim 12, further comprising:
receiving, via a main radio, a primary synchronization signal (PSS) and a secondary synchronization signal (SSS) in the SSB, wherein the SSB comprises an on-off keying (OOK)-based on/off pattern;
determining the cell ID based on the PSS, the SSS, and the OOK-based on/off pattern;
receiving, via the main radio, an orthogonal frequency-division multiplexing (OFDM)-based physical broadcast channel (PBCH) based on timing information associated with the PSS and the SSS;
receiving, via the main radio and based on the OFDM-based PBCH, a system information block (SIB); and
transmitting a message via the main radio and based on the SIB.

19. A wireless transmit/receive unit (WTRU) comprising:
a main-radio; and
a processor configured to:
receive, via the main radio, a primary synchronization signal (PSS) and a secondary synchronization signal (SSS) in a synchronization signal block (SSB), wherein the SSB comprises an on-off keying (OOK)-based on/off pattern;
determine a cell identity (ID) based on the PSS, the SSS, and the OOK-based on/off pattern;
receive, via the main radio, an orthogonal frequency-division multiplexing (OFDM)-based physical broadcast channel (PBCH) based on timing information associated with the PSS and the SSS;
receive, via the main radio and based on the OFDM-based PBCH, a system information block (SIB); and
transmit a message via the main radio and based on the SIB.

20. The WTRU of claim 19, wherein the processor is further configured to:
receive the OFDM-based PBCH via a first set of transmission occasions; and
receive an OOK-based PBCH via a second set of transmission occasions.
